(19) United States
(12) Patent Application Publication
(10) Pub. No.: US 2025/0053840 A1
(43) Pub. Date: Feb. 13, 2025

(54) COORDINATING OPERATION OF QUANTUM NETWORK NODES IN A QUANTUM NETWORK

(71) Applicant: Technische Universiteit Delft, Delft (NL)

(72) Inventors: Matthew Daniel Skrzypczyk, Delft (NL); Stephanie Dorothea Christine Wehner, Delft (NL)

(21) Appl. No.: 18/710,817

(22) PCT Filed: Nov. 21, 2022
(86) PCT No.: PCT/NL2022/050668

§ 371 Date: May 16, 2024

(30) Foreign Application Priority Data
Nov. 19, 2021 (NL) 2029849

(51) Int. Cl. G06N 10/40; H04J 3/16

(52) U.S. Cl. CPC G06N 10/40; H04J 3/1694

(57) ABSTRACT

Methods and systems for coordinating quantum network nodes include: receiving a request for establishing entanglement between first and second quantum network nodes, a path connecting the first and second nodes via intermediary network node(s); determining repeater protocols for the first and second nodes and the intermediary network node(s), each of the repeater protocols being associated with network demand rate and including repeater protocol operations and mapping information defining qubits of network nodes for each repeater protocol operation and relative timing between repeater protocol operations of a repeater protocol; constructing a cyclic network schedule including fixed time slots for signaling the first and second nodes and intermediary network node(s) when each repeater protocol should be executed, a relative offset mapping associated with a repeater protocol determining when the repeater protocol operations associated with the repeater protocol start and stop; and, sending the network schedule to the network nodes of the network.

### TECHNICAL FIELD

The embodiments relates to ccoordinating operation of quantum network nodes in a quantum network, and, in particular, though not exclusively, to methods and systems for coordinating operation of quantum network nodes in a quantum network and a software program product using such methods.

### BACKGROUND

Recent progress in developing networked quantum devices motivates the emerging field of quantum network architecture. Quantum networks promise to significantly enhance internet technology by enabling new applications that are impossible to achieve using classical (non-quantum) communication. Key to enabling quantum applications is the creation of end-to-end entanglement between two nodes in the network. Entanglement is a special property of two quantum bits (qubits) held by two nodes in the quantum network. As such, one might think of entanglement as a form of virtual or—entangled—link between the two qubits.

Application performance in quantum networks depends on several dimensions of network service. On one hand, there are traditional performance metrics such as the throughput of entanglement delivery as well as jitter (variance in inter-delivery times) for more complex applications. On the other hand, there is a genuinely quantum performance metric, namely the quality, or fidelity, of the entanglement delivered to users. Meeting application requirements and maximizing network utility motivates the design of quantum network architectures that support quality-of-service (QOS) guarantees on the distributed entanglement.

Entanglement, or entangled links, may be established between quantum network devices that are directly connected via a physical medium such as optical fiber, or free-space communication. Such devices may be referred to as connected devices. In multi-hop quantum networks, where not all devices are connected, entanglement distribution can be accomplished with the help of intermediary nodes using a procedure known as entanglement swapping. Such intermediary quantum devices are often referred to as a quantum repeater. In general, quantum repeater protocols that establish entanglement over long distances can be formed by combining several types of operations in addition to entanglement swapping. The fidelity requirement on entanglement distribution is satisfied by the exact combination of these operations, as allowed by the underlying quantum hardware. Throughput requirements are met by executing quantum repeater protocols frequently enough to distribute entanglement at the desired rate while jitter requirements are met by regulating the inter-delivery times of entanglement from the quantum repeater protocols.

Even if only two users in the network wish to communicate, the successful execution of a quantum repeater protocol requires the coordinated execution of different operations at intermediary nodes in the network. If many users wish to generate entanglement simultaneously, coordination between the actions of two disjoint repeater protocols at the level of their component operations is also required. This gives rise to a novel scheduling problem that is fundamental to the design of quantum networks.

Moreover, near-term technological limitations impose very strict demands on any coordination mechanism hoping to meet QoS requirements. Specifically, near-term quantum hardware (sometimes also referred to as noisy intermediate-scale quantum devices, NISQ) offers limited memory lifetimes (currently at most seconds), which means that entangled links cannot be stored for a long time. Furthermore, a limited storage space means that the number of entangled links that can be stored simultaneously is small. These limitations impose both real-time and resource constraints on the creation of entangled links.

Several functional allocations of quantum network stacks have been proposed in which layers are formulated based on specific protocols such as entanglement distillation. In contrast, Dahlberg et al. take a different approach in A link layer protocol for quantum networks, in ACM SIGCOMM 2019 Conference, SIGCOMM '19, page 15, New York, NY, USA, 2019. ACM and focus on the type of service each layer should provide. In this design the functional allocation with physical and link layer protocols that take practical considerations, such as hardware imperfections and communication overhead, are taken into account. Kozlowski et al. Designing a quantum network protocol. In Proceedings of the 16th International Conference on emerging Networking Experiments and Technologies (CoNEXT '20). Association for Computing Machinery, New York, NY, USA, 1-16 build upon this work and design a network layer protocol suitable for the network stack model of Dahlberg et al. Matsuo et al. Quantum link bootstrapping using a RuleSet-based communication protocol. Physical Review A 100, 5 (2019), 052320 present and simulate a RuleSet-based quantum link bootstrapping protocol that may be used to install rules to provide flexibility when establishing connections in quantum networks.

Quantum network architectures that break down entanglement distribution into discrete time steps are known. These schemes however do not describe the network infrastructure that realizes their architecture, nor do they detail any scheduling strategies for network coordination. Furthermore, these schemes depend on the production of high-quality entanglement between connected devices in order to meet high fidelity requirements between distant nodes in the network and as a result are not suitable for near-term networks. Aparicio et al. in Multiplexing schemes for quantum repeater networks, Proc. SPIE 8163, Quantum Communications and Quantum Imaging IX, 816308 (6 Sep. 2021) evaluate the usage of time-division multiplexing (TDM) in comparison to other multiplexing strategies. The described TDM scheme assigns end-to-end flows to time slots without detailing the quantum repeater protocol operations to execute. As a result, the TDM scheme does not coordinate the operation of connected devices that are limited to establishing one entangled link with another connected device at a time.

WO2021/016095 (D1) describes an architecture of a quantum network comprising multiple quantum network nodes (repeaters) and a quantum network manager for centrally managing quantum communication in such network based on a quantum policy and quantum capabilities. This document describes how such quantum network can co-exist with conventional telecommunications networks but does not address problems how entanglements between end-nodes can be coordinated taken into account the fidelity requirements of the quantum network application and the limitations of the quantum hardware, in particular the so-called noisy intermediate-scale quantum (NISQ) devices.

Hence, from the above, it follows that there is a need in the art for improved schemes that allow coordinating operation of quantum network nodes in a quantum network, in particular there is a need in the art for improved methods and system for coordinating and orchestrating operation of quantum network nodes, in particular coordinating and orchestrating delivery of end-to-end entanglement in a quantum network that meet the quality-of-services QoS requirements of applications that are executed on the quantum network nodes and that are suitable for quantum network nodes that use near term quantum hardware, such as noisy intermediate scale quantum NISQ devices.

### SUMMARY

The embodiments in this application describe novel scheduling methods and systems for scheduling quantum network nodes in a quantum network. The methods and systems may support Quality of Services (QOS) requirements of entanglement generation for applications. This may be achieved by encoding quantum repeater protocols into schedules that are distributed across the network. Fixed-duration time slots in the schedule may encode different operations of quantum repeater protocols. The encoded protocols may be selected to meet fidelity requirements, while the schedule is constructed such that the frequency of entanglement delivery meets throughput and jitter requirements. To this end, the problem of constructing schedules of quantum repeater protocols is addressed. Further, different methods, including a new heuristic, are described for solving the resulting scheduling problem. The new heuristic is compared (benchmarked) with existing heuristics adaptable to this setting on several small near-term quantum network topologies. The results show that comparable performance can be obtained while reducing runtime complexity. Further, it has been found that the choice of scheduling heuristic can be used to trade off higher network throughput for lower jitter.

The system and methods are designed to fit into an existing quantum network stack, and build upon known quantum network protocols uses as described in the above-referenced article by Dahlberg et al. The system and methods may have one or more of the following defining properties: (1) encoded repeater protocols are connection-oriented and can be tailored per application, (2) the centrally constructed schedule provides contention-free usage of net-work devices, (3) dynamic update of the schedule allows the system to accompany network demands at runtime. In contrast to known TDMA protocols used in conventional network technologies, the TDMA architecture for quantum networks multiplexes the execution of operations for quantum repeater protocols, of which there may be many on a single node just to establish a single end-to-end entangled link, rather than multiplexing access to classical channels.

In an aspect, the embodiments may relate to a method of coordinating quantum network nodes in a quantum network. The method may include: receiving a request for establishing entanglement between a first quantum network node and a second quantum network node in the quantum network, a path connecting the first quantum network node with the second quantum network node via one or more intermediary quantum network nodes.

The method may further include determining quantum repeater protocols for the first and second quantum network node and the one or more intermediary quantum network nodes to establish the entanglement, each of the quantum repeater protocols being associated with network demand rate and each of the quantum repeater protocols including quantum repeater protocol operations and mapping information, the mapping information including a resource map defining qubits of quantum network nodes that are used for each quantum repeater protocol operation and a relative offset mapping defining the relative timing between quantum repeater protocol operations of a quantum repeater protocol.

The method may also include constructing a network schedule based on the quantum repeater protocols and associated network demand rate, the network schedule being a cyclic schedule including fixed time slots for signaling the first and second quantum network node and the one or more intermediary quantum network nodes when each quantum repeater protocol should be executed, the relative offset mapping associated with a quantum repeater protocol determining when the quantum repeater protocol operations associated with the quantum repeater protocol start and stop; and, sending the network schedule to the quantum network nodes of the quantum network.

In an embodiment, the construction of the network schedule may be further based on the length of the network schedule, wherein the length of the network schedule is determined based on the network demand rates of each quantum repeater protocol and a time slot size.

Here, the network demand rate is the desired rate of entanglement delivery (in units of entanglements per time unit, e.g. seconds or time slot) that a pair of network nodes want the network to provide them. The network schedule is constructed such that entanglements are delivered to pairs of network nodes at a rate that satisfies the demand rate of the nodes

In an embodiment, determining the length of the network schedule may include: determining a period for each quantum repeater protocol based on the network demand rate associated with the quantum repeater protocol and the slot size; determining the length of the network schedule by computing the hyper-period for the quantum repeater protocol periods, preferably the hyper-period is computed as the least common multiple of the quantum repeater protocol periods.

In an embodiment, the construction of the network schedule may be further based on the number of instances for each quantum repeater protocol, wherein the number of instances is determined based on the length of the network schedule and the period of a quantum repeater protocol.

In an embodiment, the construction of the network schedule may be based on a periodic task scheduling method.

In an embodiment, the construction of the network schedule may be based on the periodic task scheduling method which includes: converting each quantum repeater protocol into a periodic task based on the network demand rate of the quantum repeater protocol; determing a periodic task schedule for the periodic tasks wherein the periodic task schedule provides start times for each quantum repeater protocol; and, producing the network schedule by allocating time slots to quantum repeater protocol operations based on the starting slot of a quantum repeater protocol and the relative offset mapping.

In an embodiment, the construction of the network schedule may be based on a resource-constrained project scheduling method.

In an embodiment, the the resource-constrained project scheduling method may include: computing a period for each quantum repeater protocol using the network demands and calculating the hyper-period of the set of quantum repeater protocols; creating an instance of an activity-on-node network for each quantum repeater protocol based on the resource map Q and relative offset map M for the quantum repeater protocol; constructing an activity-on-node network schedule based the instance of the activity-on-node network and the number of instances for each quantum repeater protocol, wherein the number of instances is determined based on the period of a quantum repeater protocol and the hyper-period; and, extract quantum repeater protocol operation from the activity-on-node network schedule.

In an embodiment, the quantum repeater protocol operations include one or more of: an elementary entanglement operation, a memory storage operation, an entanglement swapping operation and entanglement distillation operation.

In an embodiment, the cyclic network schedule may be a time division multiple access TDMA schedule.

In a further aspect, the embodiments may relate of a central controller for coordinating quantum network nodes in a quantum network. The central controller may comprise a computer readable storage medium having computer readable program code embodied therewith, and a processor, preferably a microprocessor, coupled to the computer readable storage medium, wherein responsive to executing the computer readable program code, wherein the processor may be configured to perform executable operations.

In an embodiment, the executable operations may include receiving a request for establishing one or more entanglements between a first quantum network node and a second quantum network node in the quantum network. The executable operations may include determining a path connecting the first quantum network node with the second quantum network node via one or more intermediary quantum network nodes. The executable operations may further include determining quantum repeater protocol operations for the first and second quantum network node and the one or more intermediary quantum network nodes, the quantum repeater protocol operations being determined to establish the one or more entanglements; determining mapping information, the mapping information including a resource mapping defining for each of the first and second quantum network node and the one or more intermediary quantum network nodes one or more qubits that are used for each quantum repeater protocol operation and an offset mapping defining at what time each quantum repeater protocol operation is performed. The executable operations may also include constructing a network schedule based on the quantum repeater protocol operations and the mapping information, the network schedule including time slots, the time slots including information for the first and second quantum network node and the one or more intermediary quantum network nodes to execute the quantum repeater protocol operations; and, sending the network schedule to the quantum network nodes.

In another aspect, the embodiments may relate to a network schedule construction module for constructing a network schedule for establishing entanglement between a first quantum network node and a second quantum network node via one or more intermediary quantum network nodes. The module may comprise a computer readable storage medium having computer readable program code embodied therewith, and a processor, preferably a microprocessor, coupled to the computer readable storage medium, wherein responsive to executing the computer readable program code, wherein the processor may be configured to perform executable operations.

In an embodiment, the executable operations may comprise creating a periodic task definition for each quantum repeater protocol in a set of quantum repeater protocols based on a network demand rate, the periodic task definition including a period and a worst-case execution time of a quantum repeater protocol. In an embodiment, the executable operations may comprise collecting the periodic task definitions for each quantum repeater protocol and calculating the hyper-period of the network schedule and the number of periodic task instances to schedule for each quantum repeater protocol to meet the network demand rate; determining a periodic task set schedule comprising a set of non-preemptive periodic tasks, wherein each periodic task defines a start time for each quantum repeater protocol of the set of quantum repeater protocols. In an embodiment, the executable operations may comprise determining a network schedule using the periodic task set schedule, the network schedule defining when each quantum repeater protocol starts, wherein a relative offset mapping associated with a quantum repeater protocol determines when quantum repeater protocol operations start and end.

In yet another aspect, the embodiments may relate to a network schedule construction module for constructing a network schedule for establishing entanglement between a first quantum network node and a second quantum network node via one or more intermediary quantum network nodes. The network schedule construction module may comprise a computer readable storage medium having computer readable program code embodied therewith, and a processor, preferably a microprocessor, coupled to the computer readable storage medium, wherein responsive to executing the computer readable program code, wherein the processor may be configured to perform executable operations.

In an embodiment, the executable operations may comprise computing a period for each quantum repeater protocol using the network demands and calculating the hyper-period of the set of quantum repeater protocols. In an embodiment, the executable operations may comprise creating an instance of an activity-on-node network for each quantum repeater protocol based on the resource map Q and relative offset map M for the quantum repeater protocol. In an embodiment, the executable operations may comprise constructing an activity-on-node network schedule based the instance of the activity-on-node network and the number of instances for each quantum repeater protocol, wherein the number of instances is determined based on the period of a quantum repeater protocol and the hyper-period. In an embodiment, the executable operations may also comprise extracting quantum repeater protocol operation from the activity-on-node network schedule

The embodiments may also relate to a program or suite of computer programs comprising at least one software code portion or a computer program product storing at least one software code portion, the software code portion, when run on a computer system, being configured for executing the method steps according any of the method steps described above.

The embodiments may also include a non-transitory computer-readable storage medium storing at least one software code portion, the software code portion, when executed or processed by a computer, is configured to perform the method steps according to any of method steps describe above.

The embodiments may also relate to a computer program product comprising software code portions configured for, when run in the memory of a computer, executing the method steps according to any of process steps described above.

The embodiments will be further illustrated with reference to the attached drawings, which schematically will show embodiments according to the invention. It will be understood that the invention is not in any way restricted to these specific embodiments.

### BRIEF DESCRIPTION OF THE DRAWINGS

FIGS. 1A and 1B depict a schematic of a quantum network comprising quantum network nodes and a network schedule for coordinating quantum network nodes in the quantum network according to an embodiment;

FIG. 2A-2B depicts examples of quantum repeater protocol operations according to an embodiment;

FIG. 3 depicts a schematic of a quantum network comprising quantum network nodes and a central controller according to an embodiment;

FIG. 4 depicts an example a network schedule for a quantum repeater protocol according to an embodiment;

FIG. 5 depicts a flow diagram of a central controller collecting capabilities information of nodes in a quantum network;

FIG. 6 depicts a flow diagram of a central controller distributing network resources to quantum nodes based on a network schedule;

FIG. 7 depicts a flow diagram of a central controller updating network resources for quantum nodes based on a network schedule according to an embodiment.

FIG. 8 depicts a flow diagram of quantum nodes executing a network schedule according to an embodiment of the invention

FIG. 9 depicts a flow diagram of quantum nodes executing a network schedule according to another embodiment.

FIG. 10 depicts an entanglement swap scheme search ESSS according to an embodiment;

FIG. 11 depicts an example of a directed acyclic graph DAG representing a set of quantum repeater protocol operations;

FIG. 12A-12E depicts a process of constructing a schedule using non-pre-emptive scheduling according to an embodiment;

FIG. 13A-13E depicts an example of a construction of an activity-on-node network for a three-node repeater protocol according to an embodiment;

FIG. 14A-14C illustrate a network schedule construction according to an embodiment.

### DETAILED DESCRIPTION

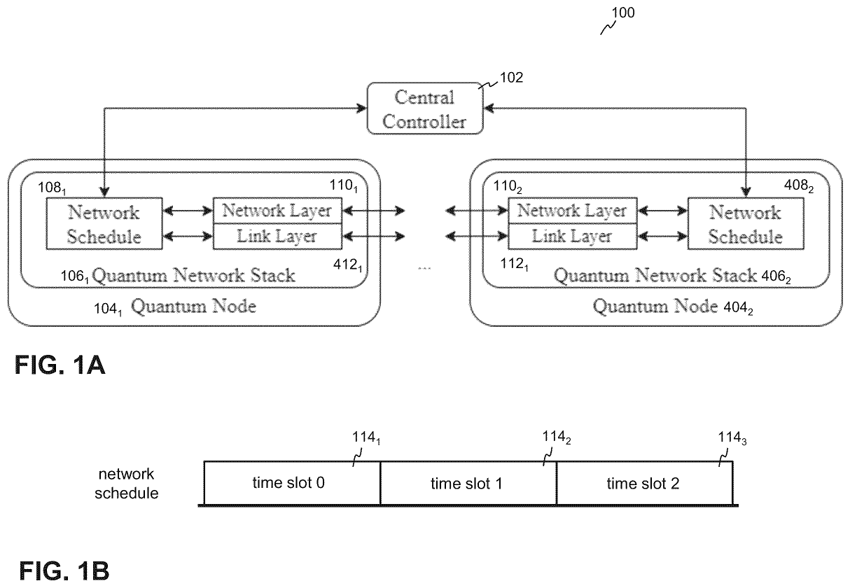

FIGS. 1A and 1B depict a schematic of a quantum network according to an embodiment of the invention. In particular, the figure depicts a quantum network comprising quantum network nodes and a network schedule for coordinating quantum network nodes in the quantum network. FIG. 1A depicts a quantum network 100 comprising network nodes, including two end nodes 102_{1,2}. Each node in the network may be implemented as a hybrid network node including a quantum node operating system 104_{1,2} running on classical hardware wherein the classical hardware is configured to establish classical communication channels, i.e. a classical connection 108 between the nodes. Each node may further include quantum hardware 106_{1,2} configured to perform local quantum computations on the node and to establish a quantum communication channel, i.e. a quantum connection 110 between nodes. The quantum hardware may include a quantum processing device including storage qubits for local storage of quantum information and for executing local quantum computation operations, e.g. gate based operations, and communication qubits for establishing a quantum connection with a quantum processing device of another end node based on quantum entanglement of the communication qubits. Based on this quantum communication channel nodes can exchange quantum information, e.g. quantum messages.

Each end-node may be configured to execute single-node application 112_{1,2}, which may include classical information processing and quantum information processing. This way, during execution of a single-node application by a first end-node, a quantum connection between the first-end node and another second end-node may be established so that at least part of the quantum information processing may be performed by the second end-node. To establish quantum connections between nodes in the network, the classical communication channels between end nodes may be used to exchange signalling information 114 for setting up and tear down quantum connections between the nodes. This way, applications executed on different end-nodes of the quantum network may communicate with each based on exchanging classical messages over the classical connections and quantum (entanglement) messages over the quantum connections. The transmission and processing of quantum messages between nodes in the network are managed by the operating system 104_{1,2}.

FIG. 1A further includes a central controller 102 configured to collect information, metrics, about the network (e.g. the topology of the network, the resources of the network nodes, network traffic, etc.) and to generate network schedules 108_{1,2}, based on the collected information. The central controller may be configured to generate network schedules for coordinating the assignment of quantum network resources to quantum network nodes that require establishment a quantum communication link through entanglement. FIG. 1B depicts an example of a network schedule generated by the central controller and provided to quantum network nodes. The schedule may include a sequence of time slots 108_{1,2} wherein different parts of the time slot can be assigned to specific quantum network operations tasks for network nodes in the quantum network. The central controller may transmit network schedules to quantum network nodes 104_{1,2} so that pairs of nodes are able to establish an entangled quantum communication link in a synchronized way. To that end, a network schedule may be provided to the quantum network stack 106_{1,2} of the quantum node operating system that runs on the quantum network node. The quantum network stack may subsequently manage the quantum communication between different quantum nodes based on the network schedule.

Resource coordination for entanglement generation between two quantum network nodes in a network of quantum network nodes requires time synchronization of processes between quantum network nodes at different levels. To schedule and coordinate resources for quantum communication to different quantum network nodes, the network scheduling protocol, may be used to achieve the required synchronization of processes on the application level and link level. The scheduling protocol requires clocks of the quantum network nodes that are being used to be synchronized, wherein the accuracy of the synchronization will depend on the application and network protocol requirements.

Additionally, the physical layer entanglement generation protocols require timing synchronization between neighbouring quantum nodes that engage in a qubit entanglement generation process. These physical layer protocols require synchronisation with much higher precision, e.g. of the order of nanoseconds with sub-nanosecond jitter, so that a further synchronization process will take place during the process of establishing an entanglement. Synchronization schemes for achieving accurate synchronization at the physical layer of the quantum network node are known. For example, the white rabbit synchronization protocol https://white-rabbit.web.cern.ch/may be used.

A reservation manager acts as an interface between applications and the central controller for expressing network demands while the entanglement manager tracks delivered entanglement and provides it to requesting applications. Network demands are forwarded to a central controller where they are subject to admission control and used to produce a new network schedule. The reservation manager installs these schedules for use by the local quantum network stack.

Due to the design considerations posed by near-term quantum devices, a centralized architecture may be selected in which a central controller is responsible for setting a network-wide schedule for end-to-end entanglement generation based on demands communicated by the end nodes. This allows mitigation of limited memory lifetimes imposing strict deadlines on the schedule of repeater protocol operations while maximizing network usage for many users. In addition, a network-wide schedule may provide a means of tracking which entangled links are used in swapping operations, ensuring entanglement is created between the correct nodes.

Before any quantum communication takes places, the nodes engage in a discussion with the central controller who acts as a repository of all information required to schedule repeater protocols. The controller holds information such as the network topology and link capabilities, i.e., the available choices of fidelity, throughput and latency at which an elementary link can be produced for each pair of connected nodes. Such topology information may be acquired using link bootstrapping protocols for characterizing QoS capabilities between connected nodes. The information may further include hardware capabilities of the individual nodes themselves, i.e. their available communication and storage qubits, the quality and speed of their operations affecting end-to-end QoS capabilities, as well as their availability for producing entanglement in given time slots. This information should be updated intermittently to keep the central controller up-to-date as near-term NISQ devices may require intermittent calibration and the capabilities of links may drift with time. Typically, the central controller has no quantum capabilities and does not participate in any quantum repeater protocol, though it requires timing synchronization with network nodes for coordinating changes to the network schedule. To prevent disruptions in network service, such a central controller should be realized using a fault-tolerant distributed computing architecture.

A quantum network includes end nodes that are connected to the network in order to run specific applications. In addition, a quantum network may include nodes that facilitate the generation of entanglement by two unconnected nodes. These are known as quantum repeaters. End nodes may also act as repeater nodes, but QoS demands only originate from applications at end nodes. In this application, the quantum nodes including end nodes or repeaters may be regarded as processing nodes. A processing node may be implemented as a qubit quantum computer with an optical interface. Implementation include qubits based on nitrogen vacancy (NV) centers in diamond, ion traps, neutral atoms and atomic ensembles.

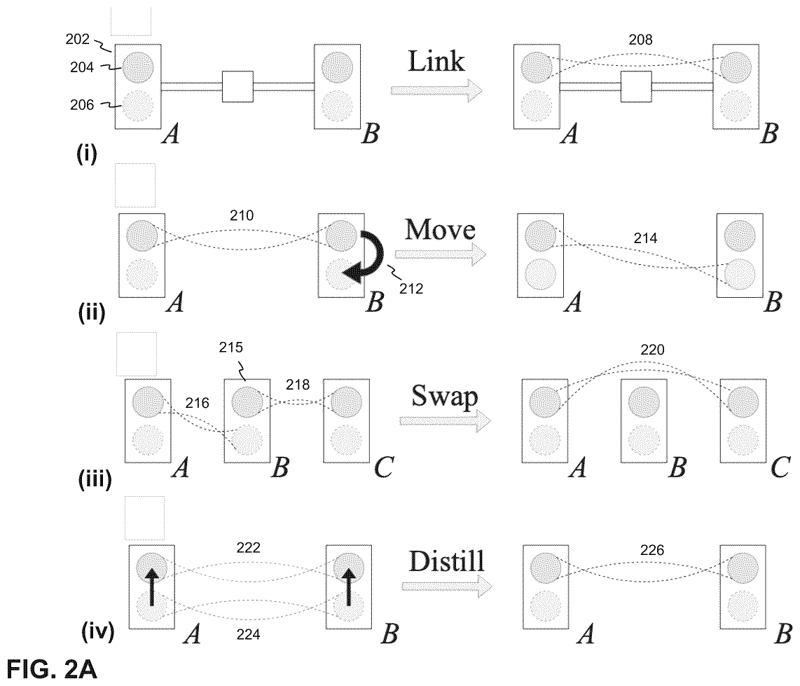

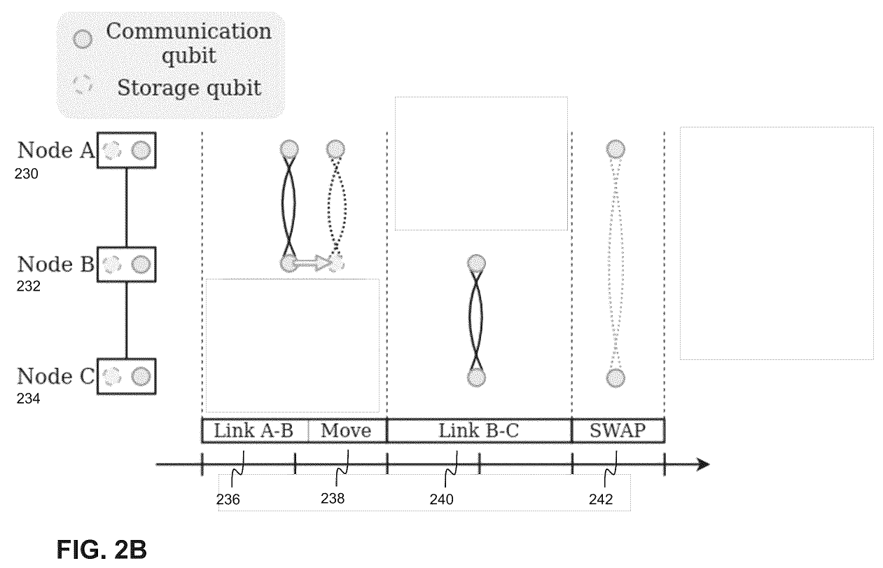

To produce long-distance entanglement, near-term quantum repeater protocols may employ a variety of operations. FIG. 2A depicts examples of quantum repeater protocol operations by nodes wherein each node 202 includes a communication qubit 204 and a storage qubit 206. These operations need to be scheduled in a coordinated manner. The figure depicts exemplary basic quantum repeater operations for producing long-distance entanglement in a quantum network according to an embodiment of the invention. In particular, the figures depict examples of basic quantum repeater operations to produce long-distance entanglement, including generation of an elementary entangled link (i.e. local entanglement) between two devices connected by a physical medium (FIG. 2A (i)), memory operation wherein certain quantum devices may move the qubit to a different location in memory in order to generate further entangled links (FIG. 2A (ii), entanglement swapping which may be used to produce an entangled link between two unconnected quantum devices (FIG. 2A (iii) and entanglement distillation which may be used to produce one (or more) entangled links with a higher fidelity (quality) from two (or more) links of lower quality (FIG. 2D (iv)).

Hence, quantum repeater protocols may be broken down into four basic operations: link generation, moving entanglement, entanglement distillation, and entanglement swapping, wherein link generation establishes entanglement between two connected quantum networking devices. Moving entanglement moves one end of the entanglement into a different qubit held by the networking devices. Entanglement distillation takes two (or more) lower-fidelity links and produces one (or more) or higher fidelity and entanglement swapping takes two entangled links held by a network node and produces one connecting the other endpoints of the links.

Two directly connected nodes (e.g. via optical connection, e.g. an optical fibre connection or a laser-based satellite connection) may establish an elementary entangled link 208 between them as depicted in FIG. 2A. Entanglement generation at the physical layer is probabilistic, and will often require several attempts before an entangled link is created. Hence, a robust link layer protocol may be used for a physical layer entanglement generation scheme that has a heralding signal confirming the success/failure. Such link layer protocol allows for a deliberate trade-off between the fidelity and the throughput of generating elementary links, depending on the capabilities of the underlying hardware. Coordinating establishment of a single entangled link between connected nodes already requires timing synchronization and agreement up to ns precision using e.g. the known White Rabbit protocol). The establishment of an elementary entangled link may be followed by a memory operation as depicted in FIG. 2A (ii) wherein certain quantum devices may move the qubit to a different location in memory, a storage qubit, so that the node can generate further entangled links.

In multi-hop quantum networks, entanglement distribution may be accomplished with the help of intermediary nodes using an operation known as entanglement swapping. An example of a swapping operation is illustrated in FIG. 2A (iii) wherein two nodes A and C that share no physical connection first produce an elementary entangled link 216,218 with the intermediary node B 215 via their shared physical medium. The fidelity requirement for such elementary links can be computed from the end-to-end QoS requirements. When both entangled links are ready, a measurement (the swapping operation) can be performed on both qubits at node B, which produces end-to-end entanglement 220 between two unconnected nodes A and C, wherein the measurement consumes the original entangled links. Since entanglement generation may be a probabilistic process, forming long distance entangled links efficiently asks for B to have a quantum memory in which the qubit of one entangled link (say the link A-B) can be stored until the second link (say B-C) is ready. Entanglement swapping operations can either be probabilistic, or deterministic depending on the underlying physical implementation.

While the embodiments in this application may also be used for systems in which swapping operations are probabilistic, the embodiments in this application assume deterministic swaps performed by processing nodes. When producing entanglement between two end nodes that are separated by one (or more) intermediary node(s), failure to achieve QoS requirements in any one entangled link in the chain leads to a failure to achieve overall end-to-end QoS.

The swapping operation should be applied to the correct entangled links, requiring the careful allocation of qubits to protocol operations across the network. Otherwise, a link between incorrect pairs of users (or none at all) may be established resulting in application failure. To meet fidelity requirements, quantum repeater protocols may also employ entanglement distillation operations which turn multiple low-fidelity links 222,224 into a fewer number of higher quality links 226. An example of such operation is depicted in FIG. 2A (iv). This operation is in general probabilistic, but a heralding signal may be produced to indicate success or failure. For all such repeater operations, the nodes need to exchange classical information, and we hence take a classical network supporting entanglement generation as a given.

FIG. 2B depicts a visualization of an execution of a quantum repeater protocol in discrete timeslots of a network schedule according to an embodiment of the invention. In particular, the figure depicts the establishment of an entangled link between two nodes, node A 230 and node C 234, via one intermediary node B 232 (e.g. a quantum repeater), wherein each nodes may include at least a communication qubit and a storage qubit. The nodes may perform operations according to a network schedule that allocates operations to specific time slots. The first operation 236 may produce an elementary entangled link between A and B. This operation may be followed by a move operation 238 to the storage qubit. The operations may be assigned into time slots of sufficient length to produce entanglement. Due to limited parallelism at device B, the elementary entangled link B-C may only be produced (operation 240) in a subsequent time period. Once the time slots of producing both elementary links with respect to and executing the move have elapsed, an entanglement swapping operation 242 may be executed, consuming the original entanglement to produce one entangled link A-C.

Technological limitations may impose stringent demands on any coordination mechanism used to produce end-to-end entanglement. First, due to limited lifetimes of quantum memories, the fidelity of an entangled link decreases exponentially with the storage time (at most seconds). Repeater nodes that lack the ability to store entanglement, or have very short storage times therefore will establish the needed links close in time. Any schedule that does not ensure that the links are produced close in time (i.e. missing deadlines) for any single hop in the chain connecting the two end nodes will hence lead to a failure in end-to-end entanglement generation with the desired QoS requirements. Second, NISQ devices can only store a limited amount of quantum information at a time. This limits the number of entangled links that a node can hold simultaneously, posing additional resource allocation challenges. Processing nodes typically have different types of qubits: communication qubits with an optical interface for entanglement generation with connected nodes, as well as storage qubits which can solely be used for storing and manipulating qubits in memory. As such, quantum repeater protocols may necessitate a move operation in memory as e.g. depicted in FIG. 2A (ii). Third, several network device platforms for processing end nodes are limited to either processing qubits (e.g. swapping or distilling operations), or establishing entanglement exclusively at any time but not both. This imposes additional timing constraints in any schedule.

Much like applications in traditional networks, applications in quantum networks may observe different traffic patterns and quality-of-service (QOS) requirements in order to execute correctly. Applications of the Measure Directly (MD) use case as described in the above-cited article by Dahlberg et al may produce many end-to-end entangled links, but do not require them to be stored nor produced at the same time. This provides flexibility in choosing throughput and jitter requirements. In contrast, applications of the Create and Keep (CK) use case described in Dahlberg et al may require storing multiple entangled links at the same time. Since memory lifetimes are short, applications of CK use cases need strict jitter requirements to ensure that sufficiently many entangled links can be produced within the same time window. In all use cases, requirements on entanglement fidelity vary depending on the error tolerance of applications, providing flexibility in the choice of quantum repeater protocols for delivering entanglement. Designing quantum networks that meet varying levels of QoS requirements thus increases the number of supported applications and consequently its utility.

Before entanglement generation for a specific application on end nodes A and B commences, A and B form a classical connection to agree on QoS requirements that entanglement generation should obey. These demands for entanglement are then communicated to the controller along with a maximal time that the end nodes are willing to wait before entanglement production starts. End nodes may also request the central controller to exclude time slots to allow time for processing entanglement between scheduled operations. The controller then produces a schedule that captures the QoS requirements. If demands exceed network capabilities or cannot be fulfilled within the desired time, the controller rejects the new demands. Once entanglement generation starts, the central controller may schedule the requested demand continuously until the end nodes ask to stop entanglement production.

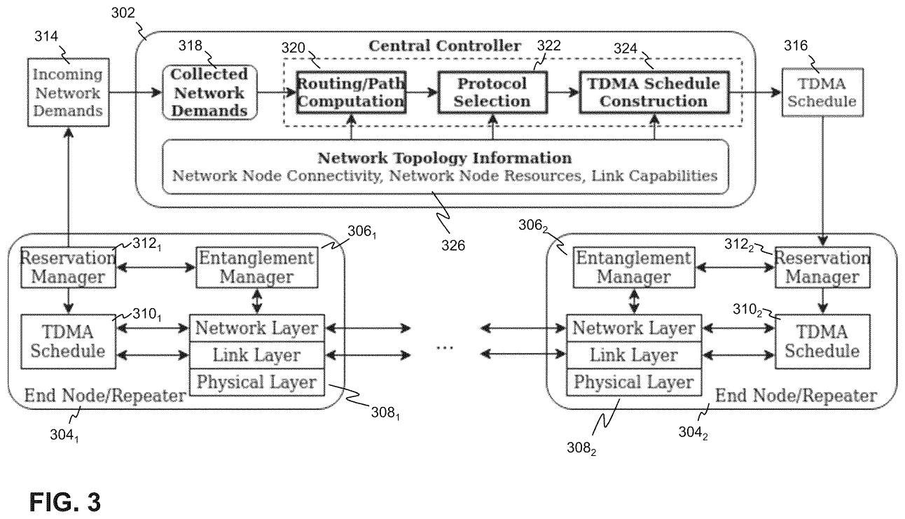

FIG. 3 depicts a schematic of a quantum network comprising quantum network nodes and a central controller according to an embodiment of the invention. In particular, the figure depicts a quantum network node comprising central controller 302 that is configured to determine network schedules, in particular TDMA schedules, for the nodes 304_{1,2}, end-nodes and intermediate (repeater) nodes, in the network. The end-nodes may be configured to execute quantum network applications, which require entanglements between different nodes in the quantum network, wherein the nodes use the network schedules to coordinate entanglement generation during the execution of the network quantum applications.

As shown in the figure, each node includes an entanglement manager 306_{1,2} configured to control a network stack 308_{1,2} for generating an entanglement link between two nodes. The network stack may include a quantum channel for establishing an entanglement link between nodes and a classical channel for exchanging classical messages that are needed for generating an entanglement link. The entanglement manager may use a network schedule 310_{1,2} to coordinate the entanglement generation, which may be provided by the central controller to the nodes. A reservation manager 312_{1,2} may provide an interface between the entanglement manager and the central controller.

Hence, user network applications executed at the end nodes A and B communicate their requirements using a reservation manager that acts as an interface between the end node and the central controller. The reservation manager provides a service interface allowing user network applications to specify demand requirements such as fidelity F, the desired number of entangled pairs N (or throughput R), and constraints on jitter J. If needed, the reservation manager may translate the number of entangled pairs N into a rate R, representing the desired number of entangled pairs per time unit (e.g. second or time slot). This rate may be referred to as the network demand entanglement rate, or in short the network demand rate, which defines the the desired rate of entanglement delivery (in units of entanglements per time unit, e.g. seconds or time slot) that a pair of network nodes want the network to provide them. The network schedule is constructed such that entanglements are delivered to pairs of network nodes at a rate that satisfies the demand rate of the nodes.

The reservation manager is responsible for submitting all application specific network demands (A, B, F, R, J) to the central controller, and for installing schedules for local use. Additionally, the reservation manager may supplement the demands with a specification of time needed to process entanglement, allowing slots to be excluded from the schedule so that end nodes can process entanglement before subsequent repeater protocol operations. If network demands are accepted by the central controller, the entanglement manager may serve the created entangled links to the applications in accordance with their requests, whenever entanglement according to the central controller's schedule becomes ready.

Each node includes a quantum network stack including a network layer, a link layer and a physical layer. Here, in an embodiment, a network layer as described in the above-mentioned article by Kozlowski et al. may be used for executing both swapping and distillation operations and is configured to communicate the associated control information, including e.g. measurement outcomes from these operations to other network nodes. In an embodiment, a link layer as described in the above-mentioned article by Dahlberg et al may be used to produce elementary entangled links with connected nodes. When the desired number of entangled links has been produced (or an application no longer desire entanglement), end nodes immediately cease to participate in the operations scheduled to serve the specific application, and the reservation manager updates the central controller.

To construct a network schedule meeting QoS requirements, the central controller includes a number of modules. First, a network demand collection module 318 may receive incoming network demands 314 originating from network nodes. Routing module 320 may compute one (or several) options on how end-to-end entanglement generation between two end-nodes could be realized such that the network demand submitted by two end nodes is satisfied. Further, the routing module may select a path between the end-nodes and a selection of repeater protocols for the selected path. As described with reference to FIG. 2B, the choice of protocol determines which operations need to be executed at which nodes along the path, as well as the dependencies of said operations and timing constraints.

Given the selection of path and the protocols, a schedule construction module 324 may map the protocol operations (and associated information) of the network demands into a joint network-wide schedule comprising fixed-duration time slots. The thus determined network schedule 316 may be provided to the reservation managers of the network nodes.

Operations may span a single, or multiple consecutive time slots, allowing additional time to be allocated to operations that require more time than others. Operations may occupy an integer number of slots, so the size of time slots has to be chosen so that the excess amount of time allocated to operations is limited thereby limiting reduction of fidelity from storing entangled links between operations. Additionally, the slot size may be upper-bounded by fixed-duration operations such as moving, entanglement swapping, and entanglement distillation as described with reference to FIG. 2A.

The scheduling structure described with reference to the embodiments in this application is beneficial for several reasons. Flexibility in time allocation to operations allows spending appropriate amounts of time creating each elementary entangled link, which depends on the capabilities of the individual connected node as well as their distance in fiber (or free-space link). The scheduling structure also allows to account for the highly varying capabilities in the different network nodes, where different platforms have different timing requirements and quality for the operations. These may even differ between two different nodes with the same underlying physical system due to the nature of early quantum hardware. Scheduling operations also ensures that qubits are exclusively allocated to each operation, granting contention-free usage of network devices to support network operation. To guarantee consistent network operation, all quantum network nodes should be time-synchronized to boundaries of slots in the schedule. Such schedule synchronization can be achieved by using known synchronization mechanisms used by network nodes for heralded entanglement generation as for example described by Dahlberg et al.

The controller may periodically install the new schedule at all or at least part of the network nodes. In an embodiment, new schedules may be installed in a synchronized fashion using a periodic reconfiguration period and having the controller instruct network nodes to switch to new schedules at pre-specified times. The period at which new schedules may be installed is a design choice that depends on the desired responsiveness of the network and the minimum amount of time required to communicate the schedules to the network nodes. As time progresses, the schedule then directs network node behavior: it dictates when network nodes execute the operations in a repeater protocol.

The demand processing pipeline for the central controller as shown in FIG. 3 may be divided into distinct steps, which are described hereunder in greater detail.

The demand processing pipeline may start by first collecting incoming network demands 314 submitted by network nodes 304_{1,2}. Depending on the desired responsiveness of the network, the central controller 302 may be designed to process new network demands periodically or once a sufficient number of network demands have been aggregated into a collection of network demands by network demand collection module 318. Collected demands may processed by a routing module 320 which is configured to determine paths of quantum network nodes to use for satisfying each network demand. At this stage, the central controller may assign paths to each network demand based on several different strategies. For example, paths may be assigned based on estimates of the achievable fidelity F and throughput R or to balance load across network resources.

After the routing process, a protocol selection module 322 may selected quantum repeater protocols comprising a combination of operations (as e.g. described with reference to FIGS. 2A and 2B) for a demand and associated path. When selecting a combination of operations, the capabilities of the nodes along a path (available qubits, quality of their memories and operations, time needed to execute operations), as well as the capabilities (fidelity, throughput, latency) for producing elementary links between connected nodes along the paths may be taken into account. The selection may include which type of qubits (communication or storage qubit) to use at which node. To provide an accurate estimate of the end-to-end fidelity, operations need to be mapped onto qubits to determine:
1. whether a sufficient number of qubits exist to execute the protocol,
2. determine any reduction in fidelity due to storage of entangled links between operations, and
3. the quality of the operations themselves.

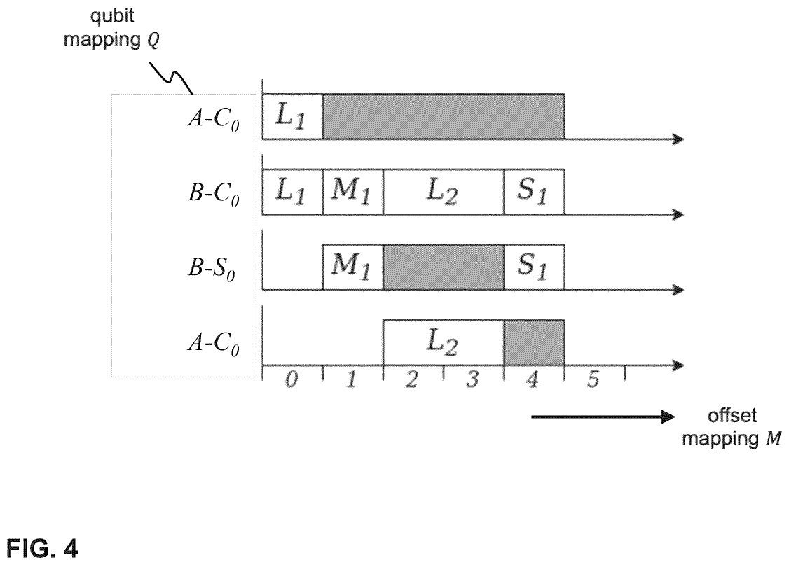

Here, latency of a quantum repeater protocol may be defined as the amount of time that elapses between the first operation and the completion of the final operation in the protocol. The latency of the quantum repeater protocols needs to be small enough to meet throughput requirements. Mapping operations to qubits allows the controller to determine these quantities and find appropriate repeater protocols. An example of such a mapping based on the quantum repeater protocol operations of FIG. 2B is illustrated in FIG. 4. This figure depicts an example of a network schedule for a quantum repeater protocol including resource mapping Q and relative offset mapping M for the repeater protocol operations. The schedule may include L (link generation), M (move), and S (entanglement swapping) operations that are mapped on time slots. The network schedule may include a mapping of the quantum repeater protocol operations onto the communication and storage qubits of a node and the relative offset mapping M of the operations on a time axis divided in time slots. Here, the relative offset mapping indicates the start and end time of each operation. The figure indicates the use of the communication qubits A−Cₒ, B−Cₒ for nodes A, B and storage qubits A−Sₒ, B−Sₒ by the repeater protocol operations, while time proceeds to the right along the horizontal axis, wherein shaded regions indicate where qubits are holding entangled links.

Specification of an operation in a network schedule may require resource requirements (communication and storage qubits to be used) as depicted in FIG. 4, but also QoS requirements (fidelity, throughput) of generating elementary links between connected nodes using a link layer protocol, allowing the nodes to correctly execute the operations. Timing constraints take into account the memory quality of the network nodes involved, to ensure that entangled links are produced sufficiently close in time to allow for end-to-end entanglement generation fulfilling network demands within the limited memory lifetimes.

Whenever an operation is probabilistic, sufficient time slots are allocated such that the operation(s) succeeds with high probability. Entanglement generation of an elementary link may be achieved robustly using the link layer protocol, where the distributed queue in the link layer may be replaced by the schedule set by the controller. Here, a sufficiently large time period may be given to the link layer protocol to succeed almost surely in producing an elementary link within that time frame. For larger end-to-end quantum repeater protocols, the probability that entanglement is successfully delivered depends on the creation of all elementary entangled links close in time. Here, a standard concentration bounds may be used to determine the amount of time allocated to each elementary entangled link such that the overall protocol is likely to succeed.

Despite scheduling probabilistic operations for sufficient time to succeed with high probability, entanglement generation may still fail. Such failures are communicated by the link and network layer to the end nodes, which then act in accordance with the application protocol to wait for the next link to succeed.

The stage demand processing pipeline of the central controller may further include a schedule construction module 324 which is configured to combine protocols for each pair of end nodes in order to construct the joint network schedule. In particular, the schedule construction module may be configured to schedule repeater protocols so that the delivery of entanglement respects QoS requirements such as throughput and jitter requirements, where the controller may make a choice of different protocols identified to meet end node demands. This stage no longer considers the end-to-end fidelity requirements as the protocols have been chosen to satisfy minimum end-to-end fidelity. The schedule may be constructed to be of a finite-length and may be executed cyclically, which means that the schedule repeats from the beginning once the end has been reached. By using a cyclic schedule, the central controller need only to broadcast a new schedule to the network when demands are changed, thereby reducing the amount of communication to keep the network running. The length of the schedule may be chosen by the controller based on the network demands. Once the schedule has been produced, the central controller may distribute the schedule to the network nodes and each node's reservation manager installs the schedule for local use. Schemes for constructing network schedules that allow generation of entanglements that respect predetermined QoS requirements are described in more detail below.

When end nodes no longer require entanglement, they may contact the central controller to remove the network demands. If applications fail to remove their demands, the schedule will still retain the corresponding repeater protocol, potentially starving new applications. To avoid this, the central controller may employ a heartbeat mechanism where end nodes regularly inform the central controller to keep their demand, allowing the controller to remove demands that it deems as inactive.

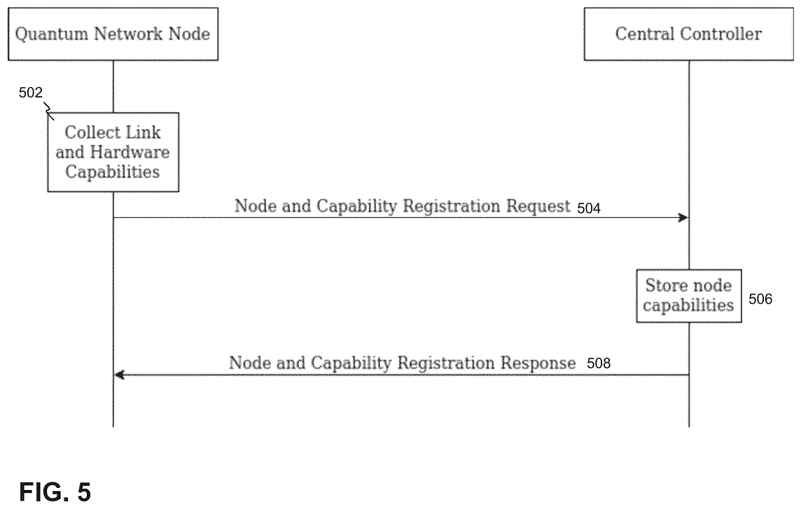

FIG. 5-9 depict flow diagrams illustrating construction and execution a network schedule in a quantum network according to an embodiment of the invention. In particular, these figures describe the execution of a demand process pipeline as executed by the central controller of the quantum network as described with reference to FIG. 1-3, wherein the central controller is configured to construct network schedules for executing quantum repeater protocols to generate entanglements that meet the quality of services QoS as requested by a quantum network application that is executed on one or more quantum network nodes of the quantum network.

In an embodiment, the execution of the demand process pipeline may include execution of the network demand collection module 318, the routing module 320, the protocol selection module 322, and the schedule construction module 324 as described with reference to FIG. 3. FIG. 5 depicts a flow diagram of a central controller collecting capabilities information of nodes in a quantum network according to an embodiment of the invention. This process may include a quantum network node collecting information about its node capabilities (step 502) and sending a registration request including the capabilities information over a classical communication line to the central controller (step 504). The central controller may store the capabilities information of the quantum network nodes in a database (step 506). Finally, the controller may send a response back to the quantum network node to signal that the registration of the information was successful (step 508).

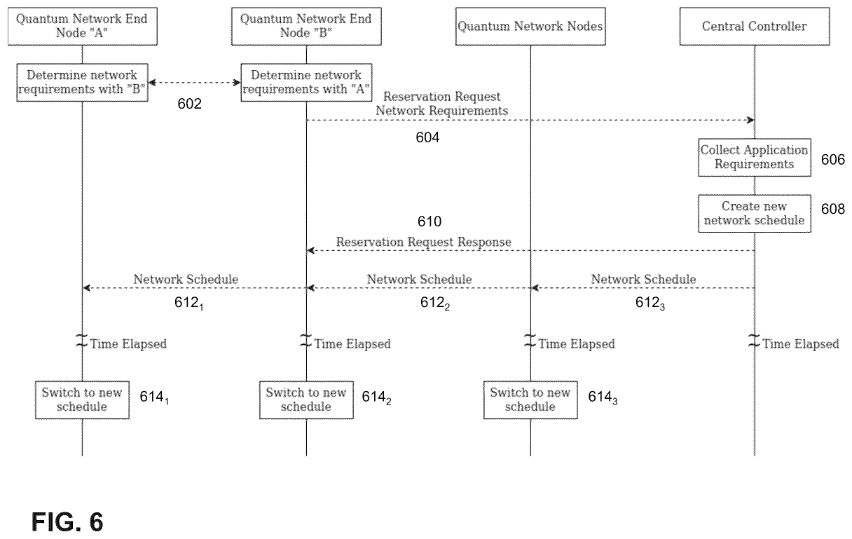

Then, if a quantum network application that is executed by end-nodes require entanglement generation between two end-nodes in a quantum network, an end-node may request the central controller to reserve network resources for the desired entanglement generation. FIG. 6 depicts a flow diagram of a central controller distributing network resources to quantum nodes based on a network schedule according to an embodiment. This process may include end-nodes that execute a quantum network application exchanging information over a classical communication channel about network requirements for an end-to-end entanglement generation (step 602). Here, in an embodiment, network requirements (or demands) may be expressed in terms of a source (a first end node) and a destination (a second end-node). In further embodiment, network requirements may include a minimum fidelity Fₘᵢₙ, a minimum rate (throughput) Rₘᵢₙ and/or a maximum jitter Jₘₐₓ. In yet a further embodiment, the network requirements may comprise a time duration in which the entanglement generation should be realized.

After determining the network requirements for the entanglement, a reservation request for network requirements may be sent to the central controller (step 604). The central controller may comprise a network demand collection module configured to collect the network requirements associated with the quantum network application (step 606). Based on the collected information, the central controller may create a new network schedule (step 608). In response to the reservation request, the central controller may inform the requesting end-nodes that the reservation request has been granted (step 610). The creation of the schedule may include: determining a routing path through the network connecting the two end-nodes, selecting quantum repeater protocol operations to establish an entanglement between the two end-nodes and constructing a network schedule based on the selected quantum repeater protocol operations and the network requirements in terms of fidelity, throughput and, optionally, jitter. The central controller may then send, e.g. broadcast, a network schedule to the network nodes (steps 612₁₋₃). The nodes, which are time synchronized, may switch over to the new network schedule and execute repeater protocol operations (steps 614₁₋₃) signaled in the network schedule.

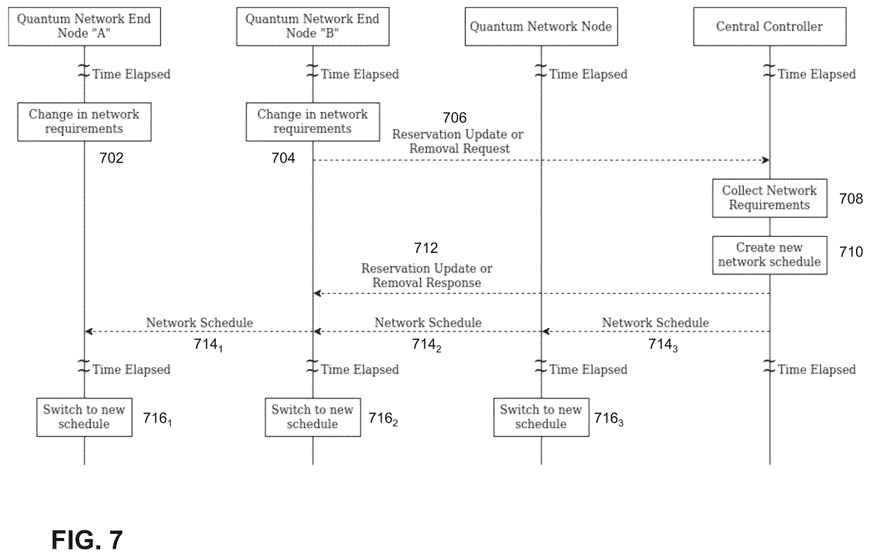

FIG. 7 depicts a flow diagram of a central controller updating network resources for quantum nodes based on a network schedule according to an embodiment of the invention. As shown in this figure, network nodes may determine that a change in the network requirements for establishing entanglements is required (steps 702 and 704). In that case, a network node may send a reservation update to the central controller comprising information regarding the network requirements (step 706). The central controller may collect reservation updates (step 708) and create a new or updated network schedule (step 710). The central controller may also inform network nodes that the updates have been received and are being processed by the central controller (step 712). The new or updated schedule is then sent, e.g. broadcasted, to the network nodes (steps 714₁₋₃) which will use the schedule at a predetermined time instance (step 716).

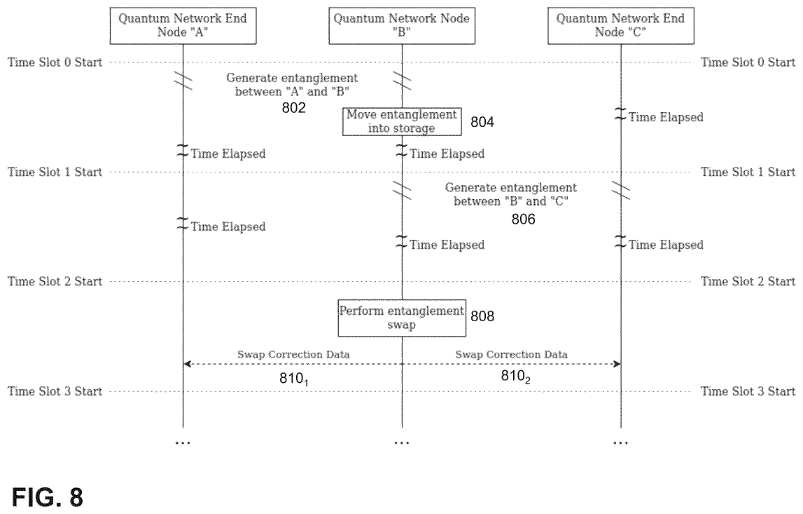

FIG. 8 depicts a flow diagram of quantum nodes executing a network schedule according to an embodiment of the invention. As shown in this figure, based on the network schedule the quantum network nodes may execute one or more quantum repeater protocol operations in a synchronized way, including generating a first elementary entanglement between first and second nodes (step 802). In an embodiment, the quantum repeater protocol operations may include moving the entangled communication qubit of the second node in a storage qubit (step 804). The quantum repeater protocol operations may include generating a second elementary entanglement between the second and a third node (step 806) and performing an entanglement swap operation by the second node to establish an entanglement between the first node and third node (which in this example may be two end nodes) (step 808). After the swap operation, the second node (an intermediate node or quantum repeater) may send information about the swap operation, e.g. swap correction data to the first and third node (step 810_{1,2}). When a swap operation is performed, entanglement is prepared in one of two states probabilistically. The swap correction data information is needed to determine which of the two states was prepared.

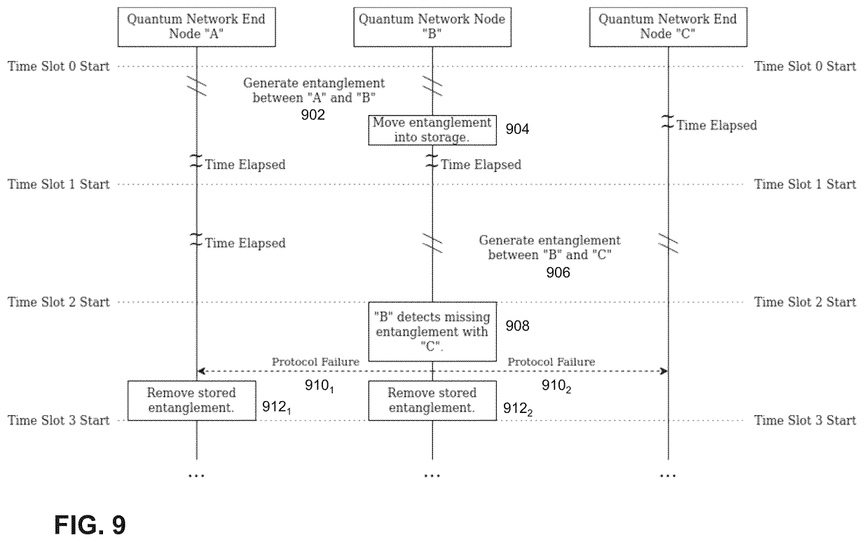

FIG. 9 depicts a flow diagram of quantum nodes executing a network schedule according to another embodiment of the invention. This flow depicts an example wherein a failure to generate an entanglement occurs. As shown in the figure, the process may start with a step 902 of generating a first elementary entanglement between first and second nodes and, optionally, moving the entangled communication qubit of the second node in a storage qubit (step 904). The process may also include the step of generating a second elementary entanglement between the second and a third node (step 906). The second node may detect that the entanglement generation with the third node was not successful (step 908). In that case, the second node may send information about the failed entanglement operation to the first and third node (step 910_{1,2}), which will remove the stored entangled qubits (step 912_{1,2}). This process may be repeated several times until entanglement is established.

Quantum repeater protocol operations chosen by the protocol selection module may be provided to the schedule construction module along with information about timing and qubit requirements. This information may include specifying the relative timing between each operation, which may be defined in a relative offset map M, and the qubits (communication qubits and/or storage qubits) that are used in each operation, which may be defined by a resource map Q. The repeater protocol operations including the mappings may be represented in a directed acyclic graph (DAG) P(A, I, M, Q), wherein the set of vertices A represents protocol operations, the set of edges/shows dependency relationships between operations, map M specifies the start and end times of operations and map Q specifies the qubits for each operation.

The problem of constructing network schedules, such as TDMA schedules, of quantum repeater protocols that meet certain QoS requirements in terms of fidelity, throughput, and jitter, may be stated as follows. Given a set of network demands D containing (src, dst, Fₘᵢₙ, Rₘᵢₙ, Jₘₐₓ) tuples detailing the source, destination, minimum fidelity, minimum throughput, and maximum jitter requirements along with their corresponding set of concrete repeater protocols P containing (A, I, M, Q) tuples for each demand, produce a schedule S with a time duration of L in seconds that maps each (demand, protocol) pair (Dᵢ, Pᵢ) to a set of start times S(Dᵢ, Pᵢ) such that:
(1) no two operations a₁, a₂∈ [symbol] Aᵢ se the same qubit at the same time,
(2) operations in Aᵢ are scheduled to respect the relative offset mapping Mᵢ of concrete repeater protocol Pᵢ(Aᵢ, Iᵢ, Mᵢ, [symbol] ᵢ). That is, for any operations a, b in Aᵢ, the jth start times s_{a,j}, s_{b,j} satisfy s_{a,j}−s_{b,j}=Mᵢ(a)−Mᵢ(b) for all i and j,
(3) no distinct operations a, b, c∈ [symbol] Aᵢ with b→c are assigned start times s_{a,j}, s_{b,k}, s_{c,k} such that s_{b,k}≤s_{a,j}≤s_{c,k} and [symbol] (a)∩ [symbol] (b)∩ [symbol] (c)≠∅ for any j, k,
(4) the entanglement delivered by each protocol Pᵢ is at least Fₘᵢₙⁱ,
(5) the average rate of entanglement delivery for demand Dᵢ satisfies minimum rate requirements, ie.

$$\frac{\vert S ( {D}_{i} , {P}_{i} ) \vert}{L} \geq {R}_{min}^{i} ,$$

and
(6) the variance in inter-delivery times for a demand Dᵢ is below Jₘₐₓⁱ, ie.

$$\frac{{\sum }_{j = 1}^{\vert S ( {D}_{i} , {P}_{i} ) \vert} {( {x}_{i , j} - {\overline{x}}_{i} )}^{2}}{\vert S ( {D}_{i} , {P}_{i} ) \vert} \leq {J}_{max}^{i} ,$$

where the first condition ensures that protocol operations are scheduled in accordance with their concrete repeater protocols so that the protocol meets minimum fidelity requirements, the next two conditions ensure contention-free usage of qubits, and the final three conditions ensure that the frequency of repeater protocol execution meets the QoS requirements. Here, |S(Dᵢ, Pᵢ)| indicates the number of times Pᵢ has been scheduled, while x_{i,j} indicates the inter-delivery time between the j-th and (j+1)-th execution of Pᵢ and is the average inter-delivery time. The definition of QoS may be selected such that it will be satisfied with high probability. The case where entanglement delivery always succeeds may be recovered by delivering a classically-correlated quantum state to applications such that the average entanglement fidelity satisfies fidelity requirements.

While the scheduling methods described with reference to the embodiments in this application are suitable for handling the timing-related QoS requirements, the scheduling methods may be selected to handle throughput requirements while fulfilling jitter requirements on a best-effort basis. The scheduling methods may be motivated by the real-time constraints imposed by near-term quantum hardware. A novel heuristic may be used that combines the two scheduling methods presented below. The heuristic is benchmarked against other known heuristics from these scheduling methods.

Given the above-mentioned problem of constructing TDMA schedules of quantum repeater protocols, different methods may be used to construct a network schedule for the quantum network nodes taken into account the above-described QoS requirements.

A first method that may be considered for constructing a schedule is the so-called non-preemptive periodic task scheduling method. In this method, each concrete repeater protocol may be transformed into a periodic task with execution requirements reflecting the protocol's latency and the QoS requirements of the corresponding demand. Preferably, non-preemptive scheduling may be used because permitting preemption of a protocol mid-execution introduces delays between operations that increase the latency of the quantum repeater protocol and also reduce the end-to-end fidelity, preventing it from meeting QoS requirements. Additionally, qubits may hold entangled links at the time of preemption, meaning they are either unavailable for use by the preempting protocol or the entangled links must be discarded, resulting in failure of the previously executing protocol.

The use of preemptive strategies may offer higher scheduling flexibility and permit additional demands to be satisfied, though this comes at the cost of ensuring that the entanglement created before the period of preemption is still present in order to resume the protocol afterwards. Furthermore, preemption of repeater protocols may introduce delays between operations which may not be permitted due to memory lifetimes. By determining a schedule for the set of periodic tasks, a corresponding network schedule can be extracted that specifies when each concrete repeater protocol Pᵢ(Aᵢ, Iᵢ, Mᵢ, Qᵢ) starts. The start and end times for each repeater protocol's operations may then be obtained by using the associated map Mᵢ.

In general, determining a valid network schedule for a set of non-preemptable periodic tasks is NP-hard, thus the choice of algorithm impacts the overhead in producing a new schedule and the network's responsiveness to changes in network demands. To achieve lower overhead, scheduling heuristics can be used to construct schedules more quickly than an exhaustive search at the cost of not scheduling some of the tasks. With respect to the class of work-conserving scheduling techniques, non-preemptive earliest-deadline first (NP-EDF) is known to be optimal, meaning that NP-EDF may schedule a set of tasks if there exists a non-preemptive work-conserving heuristic capable of scheduling the same set of tasks. The implementation of NP-EDF has a runtime complexity of O(N log N) where N is the number of scheduling decisions made.

While the periodic task scheduling method is simple, it comes at the cost of lower network throughput. By hiding fine-grained scheduling decisions on individual qubits, a lower runtime complexity can be achieved for producing a network schedule. However, under high network load this results in treating the network as a single resource, which prevents any concurrent execution of quantum repeater protocols that operate on disjoint paths in the network.

To that end, a second method is described that can be used to achieve higher network performance at the cost of additional complexity in schedule construction. This second method may use the so-called non-preemptive resource-constrained project scheduling (RCPSP) method to create a schedule. The goal of the RCPSP scheme is to schedule activities of a project under scarce resource constraints and precedence relations. In this method, quantum repeater protocols may be encoded into an activity-on-node network representing a project for RCPSP. Scheduling the activity-on-node network provides a scheduling of all quantum repeater protocol operations for the network schedule.

Similarly to periodic task scheduling, constructing a schedule based on the RCPSP scheme is NP-hard and heuristic methods may be used to find schedules more quickly. Due to the added complexity from scheduling individual resources, RCPSP heuristic solvers observe a higher complexity than periodic task scheduling heuristic algorithms. The trade-off with this higher complexity is that using RCPSP to represent the scheduling problem allows finer-grained scheduling decisions at the resource level, permitting higher levels of parallelism between repeater protocol operations.

Hereunder two heuristics for the RCPSP scheduling method are described. The first heuristic is based on the above-described non-preemptive earliest-deadline first NP-EDF heuristic, while the second heuristic combines the periodic task scheduling and RCPSP methods together into a heuristic which may be referred to as full-protocol reservation (FPR). This new heuristic approximates the activity-on-node network to a fixed-size that is independent of the number of operations in the protocol. This provides significant reductions in run-time complexity compared to the EDF RCPSP heuristic, while still achieving higher network performance than periodic task scheduling. The RCPSP-NP-EDF and RCPSP-NP-FPR heuristics have runtime complexities O(N²S²|K|log(NS)) and O(N²|K|log(N)) respectively where N is the same as in the periodic task scheduling method, |K| is the total number of qubits, and S is the maximum number of operations in any concrete repeater protocol to schedule.

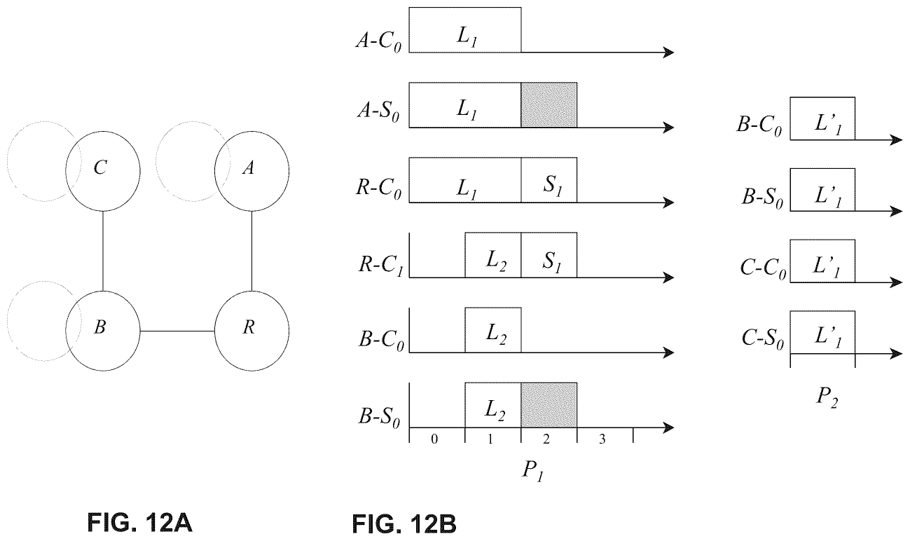

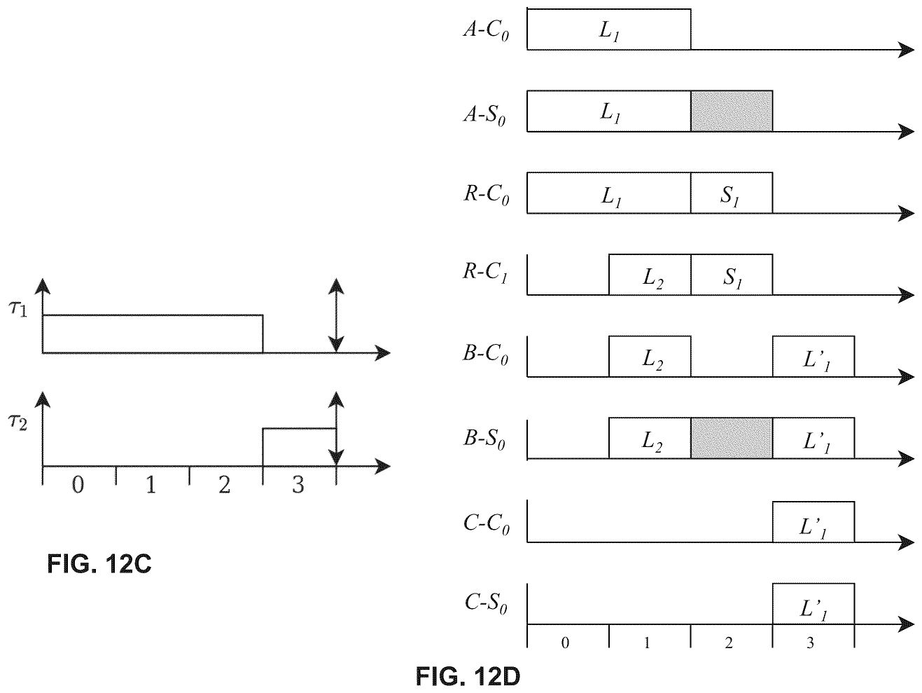

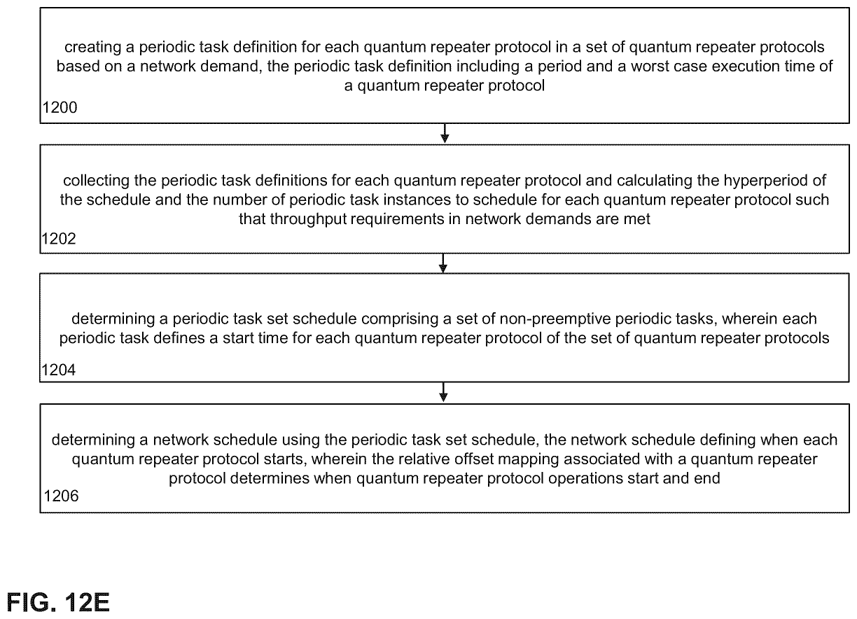

Examples of network schedule construction based on the periodic task scheduling process and the RCPSP method are described hereunder in more detail with reference to FIG. 12-14.

As described above, the demand processing pipeline of the central controller may include a protocol selection module that is configured to select a quantum repeater protocol for establishing an entanglement between two end nodes. The protocol selection module may include a heuristic algorithm to find non-concrete quantum repeater protocols for quantum devices with limited qubits. The discovered protocols may then be mapped to network resources and prescheduled to make them concrete. The heuristic may be based on a model of the physical layer of the quantum network.

The physical layer may be modelled by a topology graph G (V, E, C_{V}, S_{V}, L_{C}) where the set of vertices V represents the set of quantum network nodes and the set of edges E represents pairs of nodes that are connected C_{V} and S_{V} map a vertex v∈V to a set of communication qubits

$${C}_{V} = \{ {R}_{v , 1}^{c} , … , {R}_{v , {n}_{{C}_{v}}}^{c} \}$$

and storage qubits

$${S}_{V} = \{ {R}_{v , 1}^{s} , … , {R}_{v , {n}_{{s}_{v}}}^{s} \}$$

belonging to node v that may be used for establishing links with connected devices or holding previously established links respectively. The following assumptions on the network resources may be made:
Any pair of communication qubits (R_{u,i}^{c}, R_{v,j}^{c}) held by two network nodes u, v can be used to establish entanglement if (u, v)∈E,
The link established by a communication qubit R_{v,i}^{c} at a node v can be stored in any unoccupied storage qubit R_{v,j}^{s} held by v,
Any set of qubits (communication or storage) holding entangled links at a node v may be used for performing entanglement swapping or entanglement distillation,
Each network node can perform any operations on its local qubits in parallel. This includes generating entanglement as well as performing entanglement swapping and entanglement distillation.
Entanglement swapping and entanglement distillation at network nodes succeeds with unit probability.

Two connected nodes that wish to establish entanglement should both have an available communication qubit. If all communication qubits held by a node v contain previously established links, then no additional links may be generated. Each edge e∈E is associated with a set of link capabilities L_{c}^{e}={(F₁^{e}, R₁^{e}), . . . , (Fₖ^{e}, Rₖ^{e})} specified by L_{C} that describe the pairs of fidelity and rate at which the link may be established. Entanglement generally ceases to be useful when the fidelity F of a link falls below 0.5, thus one may assume that all link capabilities specify fidelities 0.5<F≤1.

A quantum repeater protocol that is used in the embodiments of this application may be produced for establishing entanglement between quantum network devices separated by multiple hops. Repeater protocols may achieve this by extending elementary links between connected devices to longer-distance links between unconnected devices by using entanglement swapping. Entanglement swapping takes two entangled links and consumes one to “swap” the qubit holding the end of the other link.

Entanglement swapping allows extending entangled links to larger distances but comes at a trade-off of reducing entanglement fidelity. When two entangled links with imperfect fidelity (F<1) are used for entanglement swapping, the fidelity of the resulting link is lower than that of either link used for the entanglement swap. One may assume that the state of entangled links may be written in the so-called Werner form the article by R. F. Werner. Quantum states with Einstein-Podolsky-Rosen correlations admitting a hidden-variable model. Physical Review A, 40(8):4277, 1989 (equation 1):

$${ρ}_{werner} = \frac{1 - F}{3} {𝕀}_{2} + \frac{4 F - 1}{3} \vert {Φ}^{+} 〉 〈 {Φ}^{+} \vert$$

which corresponds to a “worst-case” quantum state that is a probabilistic mixture of the perfectly entangled state |Φ⁺ [symbol] and a separable (not entangled) state 1. The fidelity F_{S} of a link produced from entanglement swapping with two entangled links of the Werner form with fidelity F₁ and F₂ can be computed as (equation 2):

$${F}_{S} = {F}_{1} {F}_{2} + \frac{( 1 - {F}_{1} ) ( 1 - {F}_{2} )}{3}$$

The reduction of fidelity from entanglement swapping poses problems for delivering entanglement of desired fidelity between end nodes. First, estimating the fidelity of the end-to-end link requires knowledge of the fidelity of all entangled links used in the quantum repeater protocol. Without an estimate of fidelity the link cannot be guaranteed to meet application requirements. Quantum repeater protocols may be tailored to meet fidelity requirements by specifying the desired fidelity of each entangled link in advance. Using equation 2 allows one to estimate the fidelity of the final entangled link.

Experimental realizations of quantum network devices may not able to produce links of perfect (F=1) fidelity, thus for higher levels of fidelity requirements quantum repeater protocols may need to resort to entanglement distillation. Entanglement distillation is a process that turns a set of lower fidelity links to produce a fewer number of higher fidelity ones. In this work we consider two-to-one entanglement distillation where two links are turned into one of higher quality. Under the Werner state assumption, the fidelity FD of a link produced from entanglement distillation of two links of fidelity F₁ and F₂ as (equation 3):

$${F}_{D} = \frac{{F}_{1} {F}_{2} + \frac{( 1 - {F}_{1} )}{3} \frac{( 1 - {F}_{2} )}{3}}{{F}_{1} {F}_{2} + {F}_{1} \frac{( 1 - {F}_{2} )}{3} + {F}_{2} \frac{( 1 - {F}_{1} )}{3} + 5 \frac{( 1 - {F}_{1} )}{3} \frac{( 1 - {F}_{2} )}{3}}$$

Entanglement distillation may be used to increase the fidelity of elementary links between connected network devices as well as those produced from entanglement swapping. Links produced from entanglement distillation may in-turn be used for entanglement swapping. Due to this flexibility, there may be many quantum repeater protocols that can be constructed to meet the same end-to-end fidelity requirement.

The so-called entanglement swap scheme search (ESSS) heuristic makes use of a constant fidelity entanglement flow heuristic for producing quantum repeater protocols. The ESSS may be understood in the following way: given a path of quantum network nodes starting at a source S and ending at a destination node D along with a minimum fidelity requirement Fₘᵢₙ and rate requirements Rₘᵢₙ, a “pivot” node P may be chosen internal to the path and repeater protocols may be recursively found on the two induced sub paths. A repeater protocol for delivering entanglement to S and D may be constructed by performing an entanglement swap at the pivot node P using the links produced by the sub paths on either side of P.

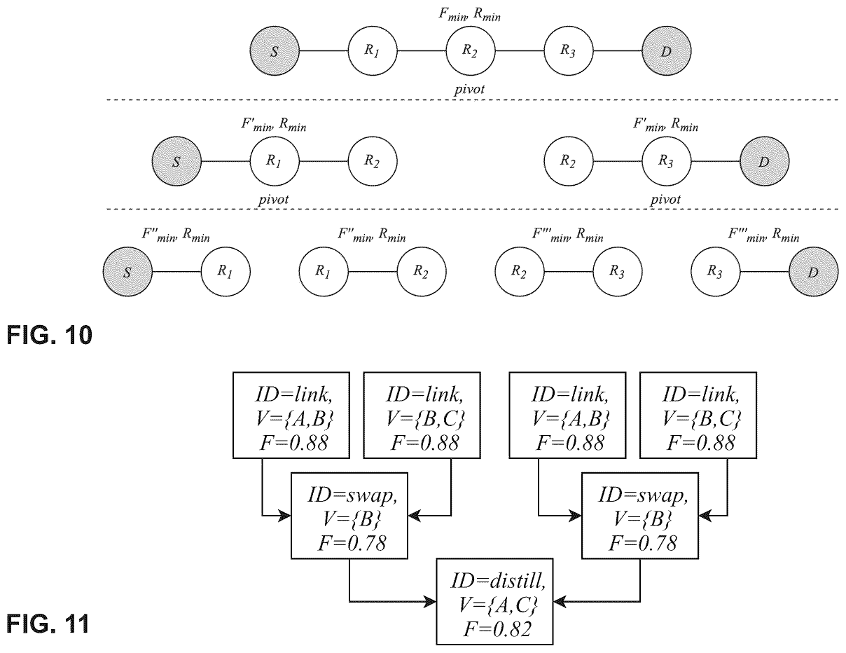

FIG. 10 depicts an entanglement swap scheme search ESSS according to an embodiment of the invention. As shown in the figure, the ESSS algorithm may start with the full repeater chain (top). A pivot may be chosen and the chain may be split in two (middle). New pivots may be chosen at each level until elementary links remain (bottom). To produce an end-to-end quantum repeater protocol that meets rate requirement Rₘᵢₙ, it should be possible to execute the repeater protocols on either side of P at a rate of at least Rₘᵢₙ as well. If the protocol “to the left” of P produces links at a rate R_{L} and the protocol “to the right” of P produces links at a rate R_{R}, then the rate R_{E} of the end-to-end protocol is lower bounded by R_{L} and R_{R}. Constructing a valid end-to-end protocol thus requires min(R_{L}, R_{R})≥Rₘᵢₙ. To meet fidelity requirements, the quantum repeater protocols on either side of P should produce entangled links that will produce a link of fidelity Fₘᵢₙ upon performing an entanglement swap at P. When assuming Werner states, one may estimate the required fidelity of both of the quantum repeater protocols by setting F₁=F₂=Fₘ, in and F_{S}=Fₘᵢₙ in equation 2 and solving for F_{m′} in. Choosing the minimum fidelity and rate requirements to be the same for both quantum repeater protocols give rise to the name of the constant fidelity entanglement flow heuristic.

The ESSS process may be used to recursively selects a pivot and divide the paths of nodes until it considers a pair of two connected quantum network devices. Entanglement swapping no longer occurs between connected devices as they may establish entanglement directly with one another. Establishing a link that meets the minimum and fidelity requirements at this level may be done by establishing a single link or by distilling several lower-fidelity links. Of these choices, the method may be selected that achieves the highest rate of link establishment.

If the repeater protocols on either side of P are found to achieve different rates R_{L} and R_{R}, the search may temporarily track an achieved rate Rₜₘₚ=min(R_{L}, R_{R}) and select a new pivot P′ to potentially produce quantum repeater protocols on either side of P′ that achieve new rates R_{L}′ and R_{R}′ such that min(R_{L}′, R_{R}′)>min(R_{L}, R_{R}). Suppose in FIG. 10 that at the top-level, one may find that the rate over nodes (S, R₁, R₂) is lower than that over (R₂, R₃, D), one may attempt to construct a new protocol by selecting R₁ as a new pivot, as a general rule of thumb is that paths of fewer network nodes may achieve higher rates of link establishment than paths of many network nodes.

The ESSS algorithm may be extended additionally consider entanglement distillation at the pivot node level. When a quantum repeater protocol is constructed by performing an entanglement swap of the two protocols on either side of P, quantum repeater protocols may be considered that produce several such links and then perform entanglement distillation to reach fidelity requirements on the protocol. The search assumes two-to-one entanglement distillation is performed and considers two styles of entanglement distillation known as entanglement pumping and nested entanglement pumping.

The modified ESSS algorithm may represent quantum repeater protocol specifications in the form of a directed acyclic graph (DAG) P(A,I). The set of vertices, A, represents the set of operations in the quantum repeater protocol, whereas the set of edges, I, represents the dependency relation between operations in the protocol. FIG. 11 depicts an example of a directed acyclic graph representing a set of quantum repeater protocol operations. In particular, the figure depicts an example of a three-node quantum repeater protocol DAG that may be produced by the modified ESSS search. Nodes may represent a specification of protocol actions (in this case an operation identifier, the pair of nodes that perform the action and fidelity of the link, while edges show dependencies between actions. An associated representation of resource mapping Q and relative offset mapping M for the repeater protocol is depicted in FIG. 4. Hence, each operation a may be associated with metadata that define the operation such as, node identifiers, fidelity and allocated time for the operation: a=(a_{ID}, a_{V}, a_{F}, a_{R})∈A wherein, a_{ID}, defines an operation type, a_{V}, the set of nodes performing the operation, a_{F}, the fidelity of the link upon performing the operation and a_{R} the amount of time to allocate to the operation. For elementary entangled link generation, a_{R} is chosen as the expected amount of time to generate the link with fidelity a_{F}.

The general framework of the ESSS may provide a method for searching for quantum repeater protocols but does not provide a means for mapping them to qubits held by the network devices. Some network devices may be restricted to producing entangled links serially, while others may produce multiple links concurrently. Characterizing the minimum latency, and hence the rate, of quantum repeater protocol execution thus requires a temporal mapping of operations in the protocol to qubits in network devices. The mapping allows one to determine the amount of time needed to execute the quantum repeater protocol and whether the protocol meets rate requirements.

Next, it is described how the quantum repeater protocols in the ESSS scheme are made concrete as needed for the schedule construction stage. This process may be referred to as concrete repeater protocol mapping. Based on a description of a quantum repeater protocol P(A,I) and a model of the physical quantum network G(V, E, C_{V}, S_{V}) a resource mapping Q may be produced and the relative offset mapping M that specify what qubits are used for each operation and when each operation is performed. Performing entanglement swapping and entanglement distillation requires previously established entangled links in order to be performed, thus for a given repeater protocol P(A,I) it is known that the set of sources in A are all operations that establish links between connected devices.

As described earlier, entangled links occupy qubits and each qubit can only store one entangled link. Thus, when a network node u performs an entanglement swap, both of the qubits held locally by v become vacant and are able to store new entangled links. The other two nodes, v and w, with which v held the entangled links with used for entanglement swapping, still have their qubits occupied as the link produced from entanglement swapping is stored in qubits held by network nodes v and w. When a pair of network nodes (u, v) perform entanglement distillation, one of the qubits at each node stores the link produced from entanglement distillation, while the second qubit becomes vacant.

Since operations in a quantum repeater protocol P(A,I) have a consumer/producer relationship and the dependency relationship on operations takes the form of a tree structure, the resource mapping Q and relative offset mapping M may be determined by performing a post-order traversal of the protocol. When a source (link establishment operation) node a is reached, the operation is mapped to communication qubits and storage qubits held by the network nodes in a_{V}. In the model, it is assumed that any communication qubit may move a link into any storage qubit held by the same node. The mapping thus attempts to always reserve a vacant communication qubit and a vacant storage qubit so that the communication qubit may store the newly established link and be available for subsequent link establishment. When no storage qubits are available, the entangled link may be left in the communication qubit as entanglement swaps or entanglement distillation that consumes the entanglement will free the communication qubit. Q(a) for a link establishment operation a is then the set of communication qubits and storage qubits chosen. The assigned qubits are then propagated through the protocol to entanglement swaps and entanglement distillations that consume the qubits. This ensures that the entangled links in the qubits are correctly paired with one another for entanglement swapping and entanglement distillation. Upon performing either of these operations, qubits become vacant as entangled links should be consumed in either process.

To determine M, a “mini” schedule for P(A,I) may be produced. The vacancy/occupation of communication qubits and storage qubits may be tracked in time as they may be used for quantum repeater protocol operations. Each operation a∈A for a quantum repeater protocol P(A, I) may be associated with an amount of time α_{R} to spend performing the operation. For link establishment, this time corresponds to the expected latency of entanglement establishment between the two connected network nodes u, v∈a_{V} for the given fidelity a_{F}. The quantum repeater protocols aim to produce a single entangled link per operation, thus operations for link establishment are allocated enough slots to permit executing for a_{R}. For entanglement swapping and entanglement distillation operations, a_{R} corresponds to the latency of performing the operation. Operations for entanglement swapping and entanglement distillation need only be allocated enough slots in the schedule to execute the operation once.

To reduce protocol latency and preserve link fidelity, in an embodiment, operations may be scheduled in two passes. The first pass may determine an as-soon-as-possible (ASAP) scheduling of the protocol operations. This determines the latency of the protocol and finds an initial scheduling. The schedule is then processed again to push link establishment as-late-as-possible (ALAP), while keeping all entanglement swap and entanglement distillation operations in place.

The protocol may be scheduled using a post-order traversal of the quantum repeater protocol with a preference to subtrees that are executed at lower rates. The motivation for this is to reduce the amount of time links must be stored before they are used for subsequent entanglement swaps and entanglement distillations. The start times of each operation in the produced schedule forms the relative offset mapping M while the qubits assigned to each operation form the resource mapping Q. This may provide a concrete quantum repeater protocol P(A, I, Q, M) that may then be provided as input to the schedule construction phase of the demand processing pipeline.

In the next step, a periodic task scheduling method may be used for constructing schedules of quantum repeater protocols. This method is described in E. F. Codd. Multiprogram scheduling: parts 1 and 2. introduction and theory. Communications of the ACM, 3(6): 347-350, 1960 and Liu et al. Scheduling algorithms for multiprogramming in a hard-real-time environment. Journal of the ACM (JACM), 20(1): 46-61, 1973. To that and, the following definitions of notation for periodic task scheduling may be used:
τᵢ=(Φᵢ, Cᵢ, Tᵢ): the i-th task, defined by three parameters: phase Φᵢ, worst-case execution time Cᵢ, and period Tᵢ.
τ_{i,j}: the j-th instance of task τᵢ.
Cᵢ: the worst-case execution time of i-th task. Corresponds each instance τ_{i,j} of τᵢ has this worst-case execution time.
Tᵢ: the period of task τᵢ, specifies the amount of time between subsequent releases of instances of tᵢ.
Φᵢ: the phase of task τᵢ, specifies the release time of task instance τ_{i,1}.
Γ: a set of tasks.
S: a schedule. Assigns a set of start times for the instances of a periodic task.

Tasks in this model are non-preemptable, meaning they may not be interrupted once they have been assigned a start time, and all task instances τ_{i,j} of task τᵢ observe the same execution time Cᵢ. Given a set of network demands D and their corresponding concrete repeater protocols P, the periodic task set Γ may be constructed as follows.

For each demand (srcᵢ, dstᵢ, F_{min,i}, R_{min,i})∈D and associated concrete repeater protocol Pᵢ(Aᵢ, Iᵢ, Mᵢ, Qᵢ), a periodic task τᵢ may be constructed with phase Φᵢ=0, worst-case execution time Cᵢ equal to the repeater protocol latency (in slots), which may be obtained from Mᵢ. Further, Tᵢ=1/tₛₗₒₜR_{min,i} may be chosen to reflect the duration of the concrete repeater protocol, while Tᵢ is chosen to respect the rate requirement of the demand.

Choosing Φᵢ=0 minimizes the length of the schedule and allows the hyper-period H to be pre-computed by the least common multiple (LCM) of the task periods LCM(T₁, . . . , Tₙ). Using non-preemptable tasks ensures the relative time mapping of each concrete repeater protocol is respected and preserves the estimated end-to-end fidelity. Modelling repeater protocols as non-preemptable tasks guarantees contention-free access to network resources.

Producing a schedule S for the periodic task set provides a set of start times for each concrete repeater protocol Pᵢ(Aᵢ, Iᵢ, Mᵢ, Qᵢ). The network schedule may be produced by allocating slots to activities based on the starting slot of a repeater protocol in the periodic task schedule and the relative time mapping Mᵢ. The standard non-preemptive periodic task scheduling problem assumes there is a single resource (a CPU) that executes tasks in the system. All tasks require exclusive access to the resource thus only a single task may execute at any time. In this scheduling method, the set of communication and storage qubits in quantum network nodes may be treated as the task resources.

This removes complexity about managing individual network resources but comes at a cost of reduced network performance. When the set of tasks contains quantum repeater protocols that execute in independent portions of the network, the produced solution will execute the protocols serially even though they may have been scheduled concurrently. One can overcome this limitation of the periodic task scheduling model by pre-processing the produced taskset Γ into a set of sub-tasksets {Γ₁, . . . , Γₘ} where each sub-taskset Γᵢ contains a subset of the tasks in Γ that share resources. No two protocols M₁, M₂ from any two unique sub-tasksets Γᵢ, Γⱼ should share any network resources. Hence, all sub-tasksets should be disjoint and the union of all sub-tasksets should provide the original taskset Γ.

Such a set of sub-tasksets may be realized by constructing a path-vertex intersection graph where the vertices represent concrete repeater protocols and edges connecting vertices represent pairs of concrete repeater protocols that share network resources. The set of vertices in each disjoint component of the path-vertex intersection graph then corresponds to a sub-taskset containing tasks that share network resources. A network-wide schedule may then be constructed by producing a schedule for each sub-taskset and merging the schedules together. Since no two schedules from the sub-tasksets share resources in their encoded repeater protocols, contention-free access is guaranteed when merging the schedules.

When there are many network demands between different end nodes in a network it is likely that many protocols will share resources with one another, preventing the decomposition of Γ into independent sub-tasksets. In this scenario, the scheduling problem cannot be decomposed to extract parallelism. This may result in treating the entirety of the network as a single resource where only one repeater protocol may be performed at any time. Constructing a path-vertex graph for a set of protocols [symbol] has a complexity of O(|K∥ [symbol] |²) where K is the set of all network resources used in the concrete repeater protocol set [symbol] . If many repeater protocols in [symbol] attempt to maximally use all communication qubits and storage qubits in network nodes, an approximation that scales better can treat each quantum network node as a single resource and achieve a complexity of O(|C∥ [symbol] |²), where C is the maximum number of network nodes used by any protocol P∈ [symbol] . Finding disjoint components may then be done in time linear with the number of vertices and edges in the path-vertex intersection graph.

FIG. 12A-12E depicts an example of a process of constructing a schedule using a non-pre-emptive periodic task scheduling method according to an embodiment of the invention. In particular, the figures illustrate a process of constructing a schedule for a chain of four quantum network nodes as shown in FIG. 12A using the periodic task scheduling method. FIG. 12B depicts a schematic illustrating a concrete repeater protocol P₁ to connect nodes A and B and a concrete repeater protocol P₂ to connect B and C. This figure depicts a resource mapping Q and relative offset mapping M for each of the concrete repeater protocols in a similar way as FIG. 4. The network demand may desire to execute a first concrete repeater protocol P₁ and a second concrete repeater protocol P₂ with a time slot size of 10 ms. Here, quantum repeater protocol operations belonging to P₁ and P₂ may be distinguished with an apostrophe in the operation label (i.e. L₁′ for P₂ and L₁ for P₁). Further the network demand for each protocol may require a rate of 25 ebit/s. With the specified slot size, this means the protocols have a period T₁=T₁=4 slots, while the periodic task τ₁ for protocol P₁ has phase Φ₁=0 and worst-case execution time C₁=3. Periodic task τ₂ for protocol P₂ has phase Φ₂=0 and worst-case execution time C₂=1. The repeater protocols overlap at node B so they must be scheduled in the same taskset.

Using a non-preemptive scheduling heuristic known as non-preemptive earliest deadline first (NP-EDF), one may obtain a periodic task schedule shown in FIG. 12C produced for periodic tasks τ₁ (P₁) 2000 and τ₂ (P₂), 2001 wherein the upward arrows represent release times of the tasks, while downward arrows represent deadlines. Hence, based on the network demand for each concrete repeater protocol, a periodic task schedule is determined with execution requirements that take into account the protocols latency and the QoS requirements. This periodic task schedule may then be transformed into the network schedule shown in FIG. 12D, wherein quantum repeater protocol operations of a quantum repeater protocol are mapped on a periodic task of the periodic task schedule. The start and end times of each quantum repeater protocol may be obtained using the relative offset map M. As shown by the network schedule, it is possible to construct a shorter schedule by placing P₂ in the vacant space during time slot 0. This is a consequence of using the periodic task scheduling method for the scheduling problem.

FIG. 12E depicts a method of constructing a network schedule using a non-pre-emptive periodic task scheduling method according to an embodiment of the invention. In particular, the method includes a step of creating a periodic task definition for each quantum repeater protocol of a set of quantum repeater protocols (step 1202). Here, each quantum repeater protocol may be associated with a demand and includes a set of quantum repeater protocol operations associated with a resource map Q and a relative offset map M.

Here, a periodic task definition may include a period of the periodic task, which may be determined based on the demand, in particular the rate of the protocol that is included in the demand. The periodic task definition may further include a worst-case execution time of the quantum repeater protocol, which may be determined on the basis of the relative offset map M.

Further, the periodic task definitions for each quantum repeater protocol may be and calculating the hyper-period H of the schedule and the number of periodic task instances to schedule for each quantum repeater protocol such that throughput requirements in network demands are met (step 1204). The length of the schedule may be determined based on the periods Tᵢ of each protocol. In particular, the length of the schedule also referred to as the hyper-period H may be computed as the least common multiple (LCM) of the task periods LCM (T₁, . . . , Tₙ). Based on the length of the schedule and the periodic task definitions, a periodic task set schedule is determined, wherein the periodic task set schedule comprises a set of non-pre-emptive periodic tasks, wherein each periodic task defines a start time for each quantum repeater protocol of the set of quantum repeater protocols (step 1206). Then, a network schedule may be determined based on the periodic task set schedule, the network schedule defining when each quantum repeater protocol starts, wherein the relative offset mapping associated with a quantum repeater protocol determines when quantum repeater protocol operations start and end (step 1208).

To evaluate the periodic task scheduling formulation, a simulated non-preemptive (NP) EDF algorithm may be implemented that splits the taskset using a path-vertex intersection graph. An example of a scheduling heuristic for the periodic task scheduling method is the well-known heuristic known as earliest deadline first (EDF). This heuristic functions by greedily choosing tasks to schedule based on which task has the earliest upcoming deadline. Non-preemptive EDF is a weakly optimal scheduling technique in the class of work-conserving schedulers, meaning that if a work-conserving non-preemptive schedule exists for a task set, then non-preemptive EDF can schedule it while satisfying the task constraints. Work-conserving schedulers try to keep scheduled resources busy whenever there are available tasks to execute. Another example of a heuristic relates to the non-work-conserving scheduling heuristic known as clairvoyant earliest deadline first (CEDF), which has shown to improve upon non-preemptive EDF when inserting idle time into the schedule in order to make more sophisticated scheduling decisions.

As already described above, the resource-constrained project scheduling (RCPSP) method may be used for constructing schedules of quantum repeater protocols. To that end, the following definitions for the RCPSP method may be used:
J: The set of all activities in the project.
jᵢ: An activity in the project.
jₛ, jₑ: Dummy start and end activities in an activity-on-node network. Has zero processing time and no resource requirements.
pᵢ: Processing time of activity jᵢ.
K: The set of all resources
hᵢₖ: Required number of resource k by activity jᵢ to execute. jᵢ may not begin unless hᵢₖ units of resource k are available
dᵢⱼ: Minimal time lag between activities jᵢ and jⱼ. Constraints the starting time of jⱼ to be at least dᵢⱼ units after the completion time of jᵢ.
\tilde{d}ᵢⱼ: Maximal time lag between activities jᵢ and jⱼ. Constraints the starting time of jⱼ to be at most dᵢⱼ units after the completion time of jᵢ.

The method first constructs an instance of the activity-on-node network for each concrete repeater protocol Pᵢ(Aᵢ, Iᵢ, Mᵢ, Qᵢ)∈P. At this level, minimal/maximal time lags between activities are chosen to respect the relative time mapping M while the project activities themselves are non-preemptable to respect the estimated end-to-end fidelity of the repeater protocol. The set of resources K is the set of communication and storage qubits present at the nodes in the network. First, construction of an activity-on-node network for a single concrete repeater protocol is described and then the construction of the full activity-on-node network for the scheduling problem is described.

Producing an instance of the activity-on-node network for a demand Dᵢ=(srcᵢ, dstᵢ, F_{min,i}, R_{min,i}) begins by constructing dummy start and end activities jₛ and jₑ with processing times pₛ=pₑ=0 and no resource requirements. A project activity j is constructed for each repeater protocol activity a∈Aᵢ with processing time p=α_{R}/tₛₗₒₜ and resource requirements hₖ=1 for all k∈Qᵢ(a). Qubits that store entangled links remain occupied until the link is used in an entanglement swap or entanglement distillation, thus we add activities to the activity-on-node network reflecting the occupation of network resources between activities. Timing constraints are added between nodes in the activity on node network based on the relative time map Mᵢ.

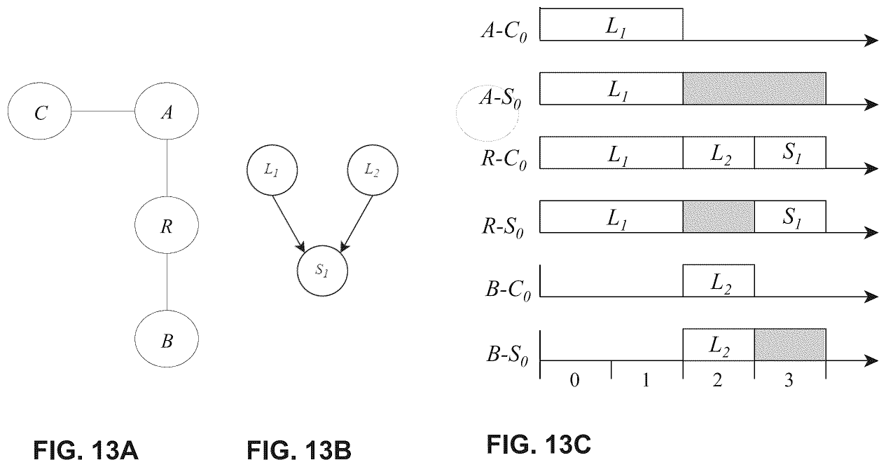

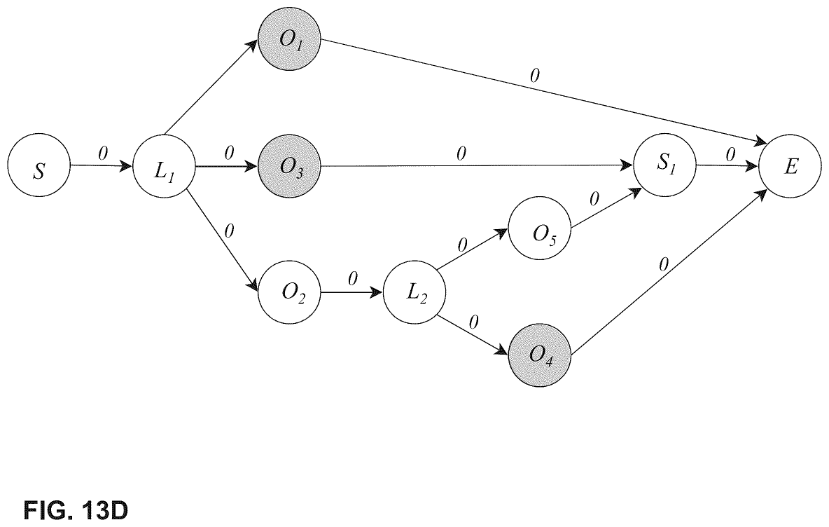

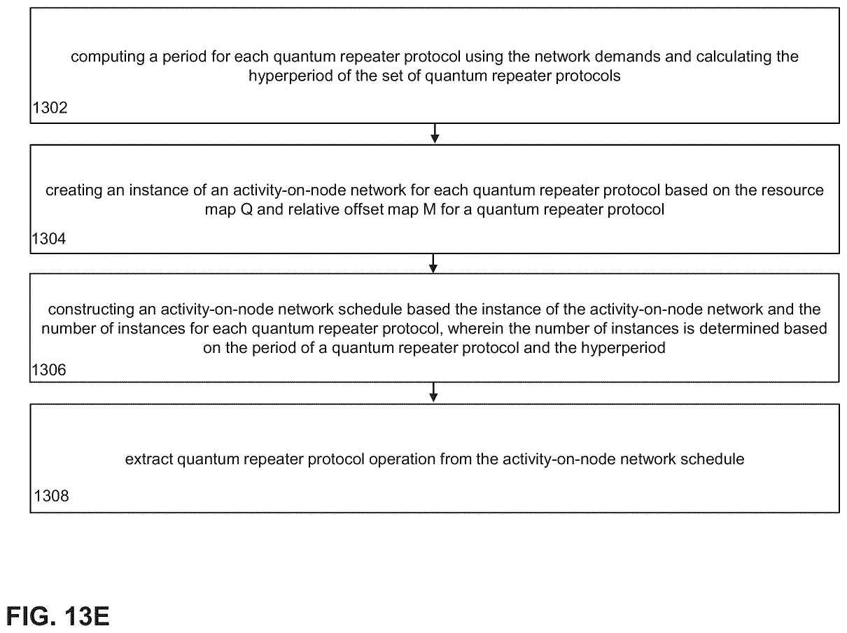

Before continuing to describe the construction of the activity-on-node network for the scheduling problem, an example of a construction of an activity-on-node network is described. FIG. 13A-13E depicts an example of a construction of an activity-on-node network for a three-node repeater protocol according to an embodiment of the invention. Consider a four-node network as shown in FIG. 13A which should perform the repeater protocol shown in FIG. 13B over the repeater chain (A, R, B). In this repeater protocol, L₁ represents an elementary link generation between A and R that requires two time slots while L₂ represents an elementary link generation between R and B that requires one time slot. S₁ is an entanglement swap that occurs at R and requires one time slot.

FIG. 13C shows a mapping of the protocol to the node resources in the case when all network nodes have one communication qubit (C₀) and one storage qubit (S₀). The shaded regions represent periods of time where the entangled links are stored. The corresponding activity-on-node network for this concrete repeater protocol is shown in FIG. 13D and the set of resources is K={A−C₀, A−S₀, R−C₀, R−S₀, B−C₀, B−S₀}. In particular, the figure depicts the activity-on-node network corresponding to the concrete repeater protocol, wherein S represents the dummy start and E the dummy end activities, while O₁, O₂, O₃, O₄ and O₅ correspond to occupation activities that reserve resources A−C₀, R−C₀, R−S₀, B−S₀, and R−C₀ respectively. In the figure, O₂ and O₅ remain unshaded as they occupy the resource for zero time units. Thus, the activities are labelled in correspondence to their protocol actions and have labelled the occupation activities with O and the dummy start and end activities as S and E. The table below summarizes the execution time and resource requirements of the occupation activities in the network while the remaining activities have these parameters specified by the concrete protocol in FIG. 13C.

| Activity | O₁ | O₂ | O₃ | O₄ | O₅ |
|---|---|---|---|---|---|
| Proc. Time ρ | 2 | 0 | 1 | 1 | 0 |
| Res. Req. | A—S₀ | R—C₀ | R—S₀ | B—S₀ | R—C₀ |

Each occupation activity corresponds to a qubit resource that needs to be reserved between actions of the protocol. The activity-on-node network for the full scheduling problem may be constructed to reflect the rate requirements of the network demand. To determine the number of each demand's activity-on-node network, the notion of a so-called hyper-period H from the periodic task scheduling method may be used. First, the period for each protocol as Tᵢ=1/tₛₗₒₜR_{min,i} and the hyper-period LCM (T₁, . . . , Tₙ) are computed. The number of instances Nᵢ of protocol Pᵢ(Aᵢ, Iᵢ, Mᵢ, Qᵢ) may then defined as H/Tᵢ. Construction of the activity-on-node network may be realized by instantiating Nᵢ instances of each protocol's activity-on-node network and connecting each instance's dummy start and dummy end to a common dummy start and end activity for the full project. Minimal and maximal time lags may be added between the dummy start and end nodes that reflect release and deadline of the activity-on-node network every Tᵢ time units.

FIG. 13E depicts a method of constructing a network schedule using the resource-constrained project scheduling (RCPSP) method according to an embodiment of the invention. The process may start with computing a period Tᵢ for each quantum repeater protocol using the network demands and calculating the hyperperiod of the set of quantum repeater protocols (step 1302). The length of the schedule may be determined based on the periods Tᵢ of each protocol. In particular, the length of the schedule also referred to as the hyper-period H may be computed as the least common multiple (LCM) of the task periods LCM(T₁, . . . , Tₙ). In the next step an instance of an activity-on-node network for each quantum repeater protocol based on the resource map Q and relative offset map M for a quantum repeater protocol may be determined (step 1304). Then, an activity-on-node network schedule may be constructed based the instance of the activity-on-node network and the number of instances for each quantum repeater protocol, wherein the number of instances is determined based on the period of a quantum repeater protocol and the hyper-period (step 1306). Thereafter, quantum repeater protocol operations may be extracted from the activity-on-node network schedule (step 1308).

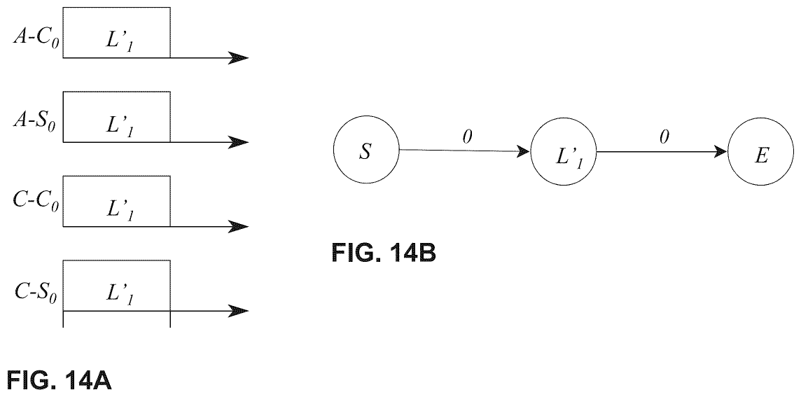

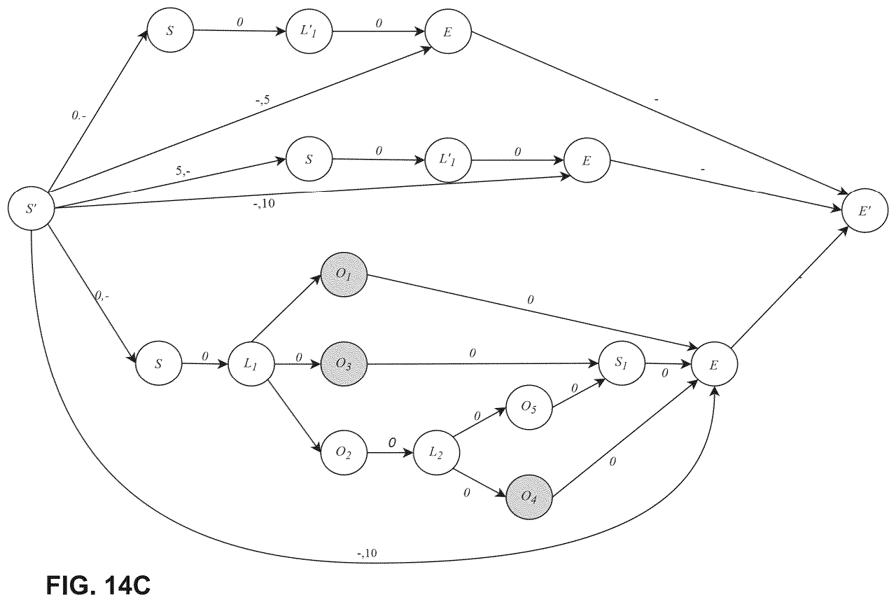

FIG. 14A-14C illustrate a network schedule construction according to an embodiment of the invention. The network construction may be based on a network that is described with reference to FIG. 13A. The example may include two demands D₁ and D₂ such that D₁ has source and destination A and B while D₂ has source and destination A and C. Suppose that the protocol in FIG. 13B corresponds to D₁ while a simple elementary link generation shown in FIG. 14A corresponds to D₂. Furthermore, suppose that the rate requirements dictate that P₁ is executed once every ten time slots while D₂ must be executed once every five time slots. FIG. 14B shows the activity-on-node network for D₂. FIG. 14C shows the activity-on-node network for the scheduling problem. In particular, the figure depicts the activity-on-node network of the concrete repeater protocols connects pairs (A, C) and (A, B) while also satisfying the demanded rates. The protocol between A and C appears twice, while the protocol between A and B appears once due to the fact that the demand rate between A and C is twice the rate between A and B. In this figure, an edge has a single value when it represents both the minimal and maximal time lags, while a pair of values x, y represent a minimal time lag of x and a maximal time lag of y. An edge labelled with “-” means that the corresponding time lag constraint is not set.

This method may be regarded of as performing periodic task scheduling across the network resources rather than a single uniprocessor shared amongst all nodes. Once a schedule has been computed, the starting times associated to the dummy jobs of each activity-on-node network may correspond to a starting time for the corresponding repeater protocol. Thus, if a schedule that satisfies the time-constrained RCPSP formulated scheme above can be constructed, then a schedule for the repeater protocols can be constructed by using the set of assigned start times.

The number of activities in the constructed activity-on-node network scales as O(NS) where N is the total number of repeater protocol instances encoded in the final network and S is the maximum number of actions in any instance of a repeater protocol. This comes from the fact that each activity in the activity-on-node network corresponds to an operation for an instance of a repeater protocol in the network. Since we construct multiple instances of each repeater protocol based on the rate of entanglements it is demanded to execute, a repeater protocol's operations may appear multiple times in the final network. The implementation for the RCPSP solver based on the EDF heuristic (referred to as RCPSP-NPEDF) has a run-time complexity that scales as O(|J|²|K|log(J)) where J is the total number of activities in the activity-on-node network and | K| is the total number of unique resources used across all concrete repeater protocols. This means that our activity-on-node construction results in a run-time that scales as O(N²S²|K|log(NS)). Such run-time may be restrictive of how frequently a central controller may produce a new schedule for the network in reaction to the opening and closing of connections. We additionally implemented an RCPSP solver inspired by the CEDF heuristic (referred to as RCPSP-CEDF) used for our investigation of the periodic task scheduling method.

To reduce the run-time complexity of producing the network schedule, a modification to method for constructing an activity-on-node network for an instance of a concrete repeater protocol may be considered. This modified scheduler, RCPSP-FPR, produces an activity-on-node network that attempts to reserve all resources used by a concrete repeater protocol for the full duration of a protocol (Full Protocol Reservation). To achieve this, one can construct an activity-on-node network for an instance of a concrete repeater protocol using three activities. First, an activity is made with execution time p equal to the repeater protocol latency (in slots) and resource requirements hₗ=1 for each qubit kₗ used by the protocol. That is, hₗ=1 if l∈∪_{a∈A}Q(a). We then attach a dummy start and dummy end activity to this activity with minimal and maximal time lags of 0. Constructing the full activity-on-node network for the scheduling problem then uses these three-node activity-on-node networks for each repeater protocol instance in the final network. This approximates the repeater protocol as a single activity that reserves all resources for execution much like how periodic tasks behave. However, since the RCPSP method is used, it is still possible to achieve higher concurrency than periodic task scheduling methods since individual resources are accounted for when scheduling the activity-on-node networks. This allows reduction of the runtime complexity as compared to our other RCPSP heuristics while still gaining an advantage from concurrent protocol execution.

Each instance of a protocol in the final network resembles a task from the non-preemptive periodic task scheduling method as described above. The advantage using an RCPSP to perform the scheduling is that finer-grained resource scheduling allows concurrent scheduling of repeater protocols in independent portions of the network, even under high network load. This modification produces activity-on-node networks of constant size for each concrete repeater protocol. Thus the size of the final activity-on-node network scales as O(N) resulting in a run-time complexity of O(N²|K|log(N)) for the solver.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described to best explain the principles of the invention and the practical application, and to enable others of ordinary skill in the art to understand the invention for various embodiments with various modifications as are suited to the particular use contemplated.

1. A computer-implemented method for coordinating generation of entanglements between quantum network nodes in a quantum network comprising:
receiving a request for establishing entanglements between a first quantum network node and a second quantum network node in the quantum network, a path connecting the first quantum network node with the second quantum network node via one or more intermediary quantum network nodes, the first and second quantum network node and the one or more intermediary quantum network nodes being time-synchronized,
determining a quantum repeater protocol to establish the entanglements, the quantum repeater protocol being associated with a network demand entanglement rate defining a desired rate of entanglements between the first and second quantum network node, the quantum repeater protocol including one or more elementary entanglement operations for establishing entanglement between connected pairs of quantum network nodes and one or more a entanglement swapping operations for establishing entanglement between quantum network nodes that are connected via an intermediate quantum network node, the quantum repeater protocol further including a resource map defining qubits of the quantum network nodes that are used for each quantum repeater protocol operation and including a relative offset map defining the relative timing between the quantum repeater protocol operations of the quantum repeater protocol;
constructing a network schedule based on the quantum repeater protocol and the network demand entanglement rate, the network schedule being a cyclic network schedule including fixed time slots for signalling the first and second quantum network node and the one or more intermediary quantum network nodes when the quantum repeater protocol should be executed, when the quantum repeater protocol operations of the quantum repeater protocol start and stop and which qubits of the quantum network nodes are used for the one or more elementary entanglement operations and the one or more entanglement swapping operations; and,
sending the network schedule to the quantum network nodes of the quantum network, the first and second quantum network node and the one or more intermediary quantum network nodes executing the quantum repeater protocol in accordance with the network schedule to establish entanglements between the first and second quantum network node at a rate that is in accordance with the network demand entanglement rate.

2. The method according to claim 1 wherein constructing the network schedule is further based on a length of the network schedule, wherein the length of the network schedule is determined based on the network demand entanglement rate of the quantum repeater protocol and a time slot size.

3. The method according to claim 2 wherein determining the length of the network schedule includes:
determining a period for the quantum repeater protocol based on the network demand entanglement rate and the slot size; and,
determining the length of the network schedule by computing a hyper-period for the period for quantum repeater protocol period.

4. The method according to claim 3, wherein constructing the network schedule is further based on a number of instances for the quantum repeater protocol, wherein the number of instances is determined based on the length of the network schedule and the period of the quantum repeater protocol.

5. The method according to claim 1 wherein constructing the network schedule is based on a periodic task scheduling method.

6. The method according to claim 5 wherein constructing the network schedule based on the periodic task scheduling method includes:
converting the quantum repeater protocol into a periodic task based on the network demand entanglement rate of the quantum repeater protocol;
determining a periodic task schedule for the periodic tasks wherein the periodic task schedule provides start times for the quantum repeater protocol; and,
producing the network schedule by allocating time slots to quantum repeater protocol operations based on a starting slot of the quantum repeater protocol and the relative offset mapping.

7. The method according to claim 1 wherein constructing the network schedule is based on a resource-constrained project scheduling method.

8. The method according to claim 7 wherein constructing the network schedule based on the resource-constrained project scheduling method includes:
computing a period for the quantum repeater protocol using the network demand entanglement rate and calculating a hyper-period of a set of quantum repeater protocols;
creating an instance of an activity-on-node network for the quantum repeater protocol based on the resource map and the relative offset map for the quantum repeater protocol
constructing an activity-on-node network schedule based the instance of the activity-on-node network and a number of instances for the quantum repeater protocol, wherein the number of instances is determined based on the period of the quantum repeater protocol and the hyper-period; and,
extract quantum repeater protocol operations from the activity-on-node network schedule.

9. The method according to claim 1 wherein the quantum repeater protocol operations further include one or more memory storage operations and/or one or more entanglement distillation operations.

10. The method according to claim 1 wherein the cyclic network schedule is a time division multiple access TDMA schedule.

11. The method according to claim 1 wherein the quantum repeater protocol is further associated with a fidelity value defining a quality of the entanglements between the first and second quantum network node, the constructing of the network schedule also being based on the fidelity value.

12. A system for coordinating generation of entanglements between quantum network nodes in a quantum network comprising:
a computer readable storage medium having computer readable program code embodied therewith, and a processor coupled to the computer readable storage medium, wherein responsive to executing the computer readable program code, the processor is configured to perform executable operations comprising:
receiving a request for establishing entanglements between a first quantum network node and a second quantum network node in the quantum network, a path connecting the first quantum network node with the second quantum network node via one or more intermediary quantum network nodes, the first and second quantum network node and the one or more intermediary quantum network nodes being time-synchronized;
determining a quantum repeater protocol to establish the entanglements, the quantum repeater protocol being associated with a network demand entanglement rate defining a desired rate of entanglements between the first and second quantum network node, the quantum repeater protocol including one or more elementary entanglement operations for establishing entanglement between connected pairs of quantum network nodes and one or more an entanglement swapping operations for establishing entanglement between quantum network nodes that are connected via an intermediate quantum network node, the quantum repeater protocol further including a resource map defining qubits of the quantum network nodes that are used for each quantum repeater protocol operation and including a relative offset map defining the relative timing between the quantum repeater protocol operations of the quantum repeater protocol;
constructing a network schedule based on the quantum repeater protocol and the network demand entanglement rate, the network schedule being a cyclic schedule including fixed time slots for signaling the first and second quantum network node and the one or more intermediary quantum network nodes when the quantum repeater protocol should be executed, when the quantum repeater protocol operations of the quantum repeater protocol start and stop and which qubits of the quantum network nodes are used for the one or more elementary entanglement operations and the one or more entanglement swapping operations; and,
sending the network schedule to the quantum network nodes of the quantum network, the first and second quantum network node and the one or more intermediary quantum network nodes executing the quantum repeater protocol in accordance with the network schedule to establish entanglements between the first and second quantum network node at a rate that is accordance with the network demand entanglement rate.

13. The system according to claim 12, wherein the processor is further configured to perform executable operations comprising constructing the network schedule is further based on a length of the network schedule, wherein the length of the network schedule is determined based on the network demand entanglement rate of the quantum repeater protocol and a time slot size.

14. The system according to claim 13, wherein determining the length of the network schedule includes:
determining a period for the quantum repeater protocol based on the network demand entanglement rate and the slot size; and,
determining the length of the network schedule by computing a hyper-period for the period for quantum repeater protocol period.

15. A non-transitory computer-readable storage medium storing at least one software code portion, the software code portion, when executed or processed by a computer, is configured to perform a computer-implemented method for coordinating generation of entanglements between quantum network nodes in a quantum network, the software code portion comprising:
receiving a request for establishing entanglements between a first quantum network node and a second quantum network node in the quantum network, a path connecting the first quantum network node with the second quantum network node via one or more intermediary quantum network nodes, the first and second quantum network node and the one or more intermediary quantum network nodes being time-synchronized;
determining a quantum repeater protocol to establish the entanglements, the quantum repeater protocol being associated with a network demand entanglement rate defining a desired rate of entanglements between the first and second quantum network node, the quantum repeater protocol including one or more elementary entanglement operations for establishing entanglement between connected pairs of quantum network nodes and one or more an entanglement swapping operations for establishing entanglement between quantum network nodes that are connected via an intermediate quantum network node, the quantum repeater protocol further including a resource map defining qubits of the quantum network nodes that are used for each quantum repeater protocol operation and including a relative offset map defining the relative timing between the quantum repeater protocol operations of the quantum repeater protocol;
constructing a network schedule based on the quantum repeater protocol and the network demand entanglement rate, the network schedule being a cyclic schedule including fixed time slots for signalling the first and second quantum network node and the one or more intermediary quantum network nodes when the quantum repeater protocol should be executed, when the quantum repeater protocol operations of the quantum repeater protocol start and stop and which qubits of the quantum network nodes are used for the one or more elementary entanglement operations and the one or more entanglement swapping operations; and,
sending the network schedule to the quantum network nodes of the quantum network, the first and second quantum network node and the one or more intermediary quantum network nodes executing the quantum repeater protocol in accordance with the network schedule to establish entanglements between the first and second quantum network node at a rate that is in accordance with the network demand entanglement rate.

16. The method of claim 3, wherein the hyper-period is computed as a least common multiple of the period for the quantum repeater protocol period.
